(19) United States
(12) Patent Application Publication
(10) Pub. No.: US 2003/0050398 A1
(43) Pub. Date: Mar. 13, 2003

(54) Novel epoxy compounds having an alicyclic structure, polymer compounds, resist materials, and patterning methods

(76) Inventors: Koji Hasegawa, Niigata-ken (JP); Takeshi Kinsho, Niigata-ken (JP); Takeru Watanabe, Niigata-ken (JP)

Correspondence Address: MYERS BIGEL SIBLEY & SAJOVEC, PO BOX 37428, RALEIGH, NC, 27627, US

(21) Appl. No.: 10/189,706

(22) Filed: Jul. 3, 2002

(30) Foreign Application Priority Data
Jul. 9, 2001 (JP) 2001-207289

(51) Int. Cl. C08F 8/00

(52) U.S. Cl. 525/107

(57) ABSTRACT

Provided is a novel epoxy compound useful, in photolithography, as a monomer for preparing a photoresist material excellent in transparency and affinity to a substrate. More specifically, provided are an epoxy compound represented by the following formula (1):

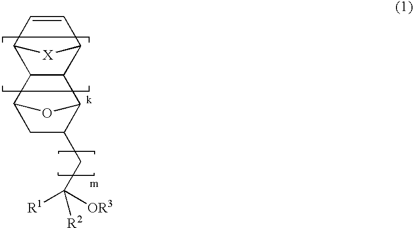

wherein, R¹ and R² each independently represents a hydrogen atom or a linear, branched or cyclic C₁₋₁₀ alkyl group in which hydrogen atoms on one or more constituent carbon atoms thereof may be partially or entirely substituted by one or more halogen atoms, or the constituent —CH₂— may be substituted by an oxygen atom, or R¹ and R² may be coupled together to form an aliphatic hydrocarbon ring; R³ represents a linear, branched or cyclic C₁₋₁₀ alkyl group or a C₁₋₁₅ acyl or alkoxycarbonyl group in which hydrogen atoms on one or more constituent carbon atoms thereof may be partially or entirely substituted by one or more halogen atoms; X represents CH₂, oxygen or sulfur; k stands for 0 or 1; and m stands for an integer of 0 to 5; and a polymer compound having recurring units available therefrom.

### BACKGROUND OF THE INVENTION

1. Field of the Invention

The present invention relates to chemically amplified resist materials suited for microfabrication technique, more specifically, to novel epoxy compounds useful as monomers for forming polymer compounds for base resin, polymer compounds containing one or more recurring units available from the epoxy compounds, resist materials containing the polymer compounds as base resin and patterning method using the resist materials.

2. Description of the Related Art

In order to cope with a recent tendency of LSI technology to higher integration and higher operation speed, the miniaturization of a pattern rule has been demanded. Under such a circumstance, far-ultraviolet lithography has been regarded promising as a next-generation of micro-lithography. In particular, photolithography using a KrF or ArF excimer laser as a light source is eagerly desired to reach the practical level as a technique indispensable for nano-microfabrication capable of achieving a pattern of 0.3 μm or less.

Resist materials used for photolithography, which uses as a light source an excimer laser light, especially an ArF excimer laser light having a wavelength of 193 nm, are, of course, required to have high transparency at this wavelength. In addition, they are required to have high etching resistance even under the tendency to decrease film thickness, a high sensitivity sufficient to permit operation of an expensive optical material without an extra burden, and above all, a high resolution sufficient to permit formation of minute patterns with accuracy. To satisfy these requirements, development of a base resin having high transparency, high rigidity and high reactivity is inevitable. Known polymer compounds known to date are not equipped with all of these properties so that resist materials having a practically usable level are not yet available.

Copolymers of an acrylic or methacrylic acid derivative and polymer compounds containing in the backbone thereof an alicyclic compound derived from a norbornene derivative are known as highly transparent resins. None of them is satisfactory. For example, copolymers of an acrylic or methacrylic acid derivative can be imparted with a higher reactivity relatively easily because highly reactive monomers can be introduced therein or acid-labile groups can be increased as desired. It is however difficult to heighten their rigidity because of their backbone structure. On the other hand, polymer compounds containing an alicyclic compound in their backbone have rigidity within an acceptable range, but the reactivity with an acid cannot be heightened readily. Because compared with poly(meth)acrylate, they are low in both of the reactivity and flexibility of polymerization, limited by their backbone structure. They are also accompanied with the defect that they cannot exhibit good adhesion when they are applied to a substrate owing to high hydrophobicity of the backbone. Accordingly, resist materials prepared using these polymers as a base resin are satisfactory in sensitivity and resolution but they do not have resistance to etching withstand etching. Or, if they have etching resistance falling within a permissible range, on the other hand, their sensitivity and resolution are below the practically acceptable level.

(Meth)acrylic and alicyclic resist materials involve, in common, a problem of pattern collapse due to swelling of the resist film. In these resist materials, their resolution performance has so far been improved by widening the difference in the dissolution rate before and after exposure, which however inevitably brings about marked heightening of hydrophobicity. Although highly hydrophobic resist materials are capable of maintaining the strength of the film at an unexposed portion and dissolving the film instantly at the over-exposed portion, they cause not dissolution but swelling at the remaining wide exposed portion in spite of permitting inflow of a developer. Resist materials not free from collapse of patterns due to mutual adhesion cannot be used for patterns of an extremely minute size to be exposed to an ArF excimer laser. As there is increasingly a demand for further miniaturization of pattern rules, resist materials are required to be suppressed in swelling as much as possible, in addition to having excellent sensitivity, resolution property and etching resistance. The term “(meth)acrylate” as used herein means methacrylate or acrylate.

### SUMMARY OF THE INVENTION

An object of the present invention is to provide, in photolithography using a light of wavelength of 300 nm or less, especially, an ArF excimer laser as a light source, a novel epoxy compound useful as a monomer for preparing a photoresist material excellent in transparency and affinity to a substrate, a polymer compound having one or more recurring units available from the epoxy compound, a resist material comprising the polymer compound as a base resin, and a patterning method using the resist material.

The present inventor has proceeded with an extensive investigation with a view toward attaining the above-described object. As a result, it has been found that an epoxy compound represented by the below-described formula (1) is available conveniently in a high yield by the below-described process, a resin prepared using the epoxy compound is highly transparent at an exposure wavelength of an excimer laser exposed, and a resist material using the resin as a base resin is excellent in resolution and adhesion to substrate.

In one aspect of the present invention, there is thus provided an epoxy compound represented by the following formula (1):

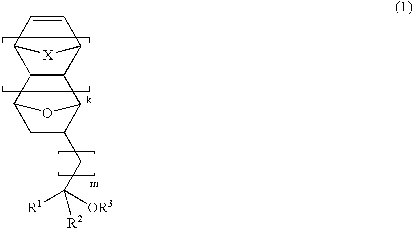

wherein, R¹ and R² each independently represents a hydrogen atom or a linear, branched or cyclic C₁₋₁₀ alkyl group in which hydrogen atoms on one or more constituent carbon atoms thereof may be partially or entirely substituted by one or more halogen atoms, or the constituent —CH₂— may be substituted by an oxygen atom, or R¹ and R² may be coupled together to form an aliphatic hydrocarbon ring; R³ represents a linear, branched or cyclic C₁₋₁₀ alkyl group or a C₁₋₁₅ acyl or alkoxycarbonyl group in which hydrogen atoms on one or more constituent carbon atoms thereof may be partially or entirely substituted by one or more halogen atoms; X represents CH₂, oxygen or sulfur; k stands for 0 or 1; and m stands for an integer of 0 to 5.

In another aspect of the present invention, there are also provided a polymer compound having one or more recurring units available by the epoxy compound of the above-described formula (1); and a resist material containing the polymer compound as a base resin.

In a further aspect of the invention, there is also provided a patterning method comprising the steps of applying the resist material to a substrate; exposing the substrate to high energy beams or electron beams through a photomask after heat treatment; and developing using a developer after heat treatment.

A resist material prepared using a polymer containing the epoxy compound of the invention as a monomer is responsive to high energy beams, and excellent in adhesion with a substrate, sensitivity, resolution and etching resistance. Such a material is useful for microfabrication by electron beams or far ultraviolet rays. In particular, the resist material has small absorption at the exposure wavelength exposed to an ArF excimer laser or KrF excimer laser, which facilitates formation of micropatterns vertical to the substrate. It is therefore suited as a micropattern forming material for fabrication of VLSI.

### DETAILED DESCRIPTION OF THE PREFERRED EMBODIMENT

The present invention will hereinafter be described more specifically.

The epoxy compound of the invention is represented by the formula (1). In the formula (1), R¹ and R² each independently represents a hydrogen atom or a linear, branched or cyclic C₁₋₁₀ alkyl group in which hydrogen atoms on one or more constituent carbon atoms thereof may be partially or entirely substituted by one or more halogen atoms. Examples of such an alkyl group include methyl, ethyl, n-propyl, isopropyl, n-butyl, sec-butyl, tert-butyl, tert-amyl, n-pentyl, n-hexyl, cyclopentyl, cyclohexyl, bicyclo[2.2.1]heptyl, bicyclo[2.2.2]octyl, bicyclo[3.3.1]nonyl, bicyclo[4.4.0]decanyl, adamantyl, trifluoromethyl, 2,2,2-trifluoroethyl, 2,2,2-trichloroethyl, 3,3,3-trifluoropropyl, and 3,3,3-trichloropropyl. R¹ and R² may be coupled together to form an aliphatic hydrocarbon ring. Specific examples of the ring formed by R¹ and R² include cyclopropane, cyclobutane, cyclopentane, cyclohexane, bicyclo[2.2.1]heptane, bicyclo[2.2.2]octane, bicyclo[3.3.1]nonane, bicyclo[4.4.0]decane and adamantane.

R³ represents a linear, branched or cyclic C₁₋₁₀ alkyl group or a C₁₋₁₅ acyl or alkoxycarbonyl group in which hydrogen atoms on one or more constituent carbon atoms thereof may be partially or entirely substituted by one or more halogen atoms. Specific examples include methyl, ethyl, n-propyl, isopropyl, n-butyl, sec-butyl, tert-butyl, tert-amyl, n-pentyl, n-hexyl, cyclopentyl, cyclohexyl, bicyclo[2.2.1]heptyl, bicyclo[2.2.2]octyl, bicyclo[3.3.1]nonyl, bicyclo[4.4.0]decanyl, adamantyl, trifluoromethyl, 2,2,2-trifluoroethyl, 2,2,2-trichloroethyl, 3,3,3-trifluoropropyl, 3,3,3-trichloropropyl, formyl, acetyl, ethylcarbonyl, pivaloyl, methoxycarbonyl, ethoxycarbonyl, tert-butoxycarbonyl, trifluoroacetyl, trichloroacetyl, and 2,2,2-trifluoroethylcarbonyl. X represents CH₂, oxygen or sulfur.

Letter k stands for an integer of 0 or 1, while m stands for an integer of 0 to 5, preferably an integer of 0 to 3.

The epoxy compound of the formula (1) is preferably an epoxy compound represented by the below-described formula (2):

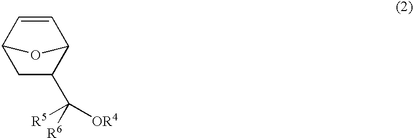

In the formula (2), R⁴ represents a linear, branched or cyclic C₁₋₁₀ alkyl group or a C₁₋₁₅ acyl or alkoxycarbonyl group in which hydrogen atoms on one or more constituent carbon atoms thereof may be partially or entirely substituted by one or more halogen atoms. Specific examples include methyl, ethyl, n-propyl, isopropyl, n-butyl, sec-butyl, tert-butyl, tert-amyl, n-pentyl, n-hexyl, cyclopentyl, cyclohexyl, bicyclo[2.2.1]heptyl, bicyclo[2.2.2]octyl, bicyclo[3.3.1]nonyl, bicyclo[4.4.0]decanyl, adamantyl, trifluoromethyl, 2,2,2-trifluoroethyl, 2,2,2-trichloroethyl, 3,3,3-trifluoropropyl, 3,3,3-trichloropropyl, formyl, acetyl, ethylcarbonyl, pivaloyl, methoxycarbonyl, ethoxycarbonyl, tert-butoxycarbonyl, trifluoroacetyl, trichloroacetyl, and 2,2,2-trifluoroethylcarbonyl.

R⁵ and R⁶ each independently represents a hydrogen atom or a linear, branched or cyclic C₁₋₆ alkyl group. Specific examples include methyl, ethyl, n-propyl, isopropyl, n-butyl, sec-butyl, tert-butyl, tert-amyl, n-pentyl, n-hexyl, cyclopentyl and cyclohexyl.

Specific examples of the epoxy compound represented by the formula (1) or (2) include those represented by the below-described structural formulas (13) to (40).

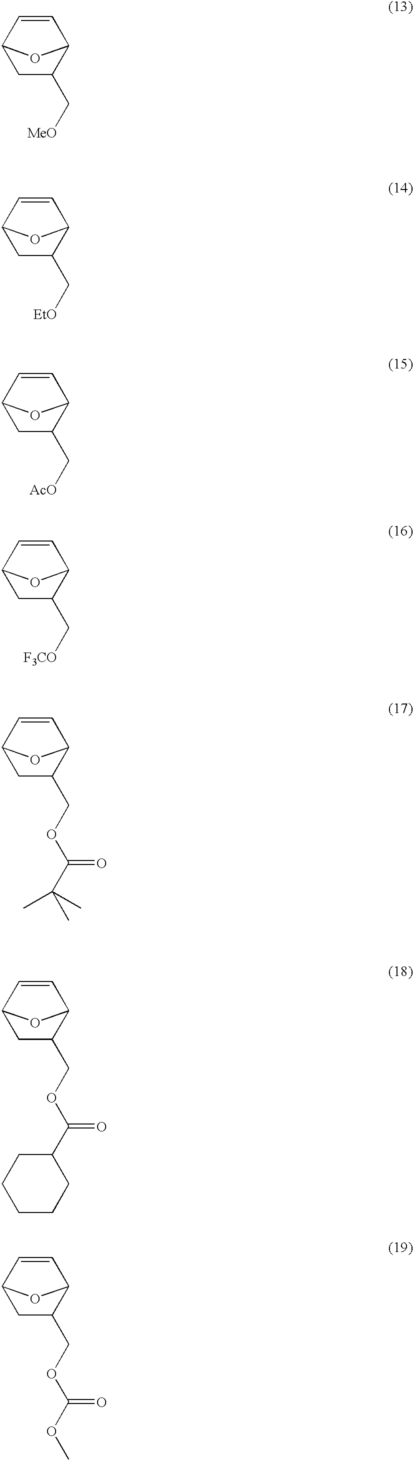

In a resist polymer using the above-described compound as a monomer, introduction of an epoxy group which may inhibit swelling upon development in the backbone of the polymer as shown in the structural formulas (13) to (34) and (37) to (40), or introduction of the epoxy group in the vicinity of the polymer backbone as shown in the structural formulas (35) and (36) makes it possible to place the —OR³ of the formula (1), which is presumed to be a polar group for exhibition of adhesion, apart from the polymer backbone by a linker ((CH₂)ₘ of the formula (1)). The compound therefore exhibits good adhesion to a substrate. By adopting a suitable one as each of R¹, R², R³, k and m and by using the resulting monomer as a raw material for a polymer, the fat solubility of the whole polymer can be adjusted properly, whereby the solubility characteristics of the polymer can be controlled.

The epoxy compound of the present invention represented by the formula (1) can be available in accordance with the below-described reaction scheme. A first step of the scheme is obtaining an intermediate alcohol compound of the formula (10) by the below-described sub-steps i) to v), and a second step is alkylating (etherifying), acylating or alkoxycarbonylating (esterifying) the hydroxyl group of the resulting alcohol compound of the formula (10) by sub-step vi). The preparation process is, however, not limited to the above-described one.

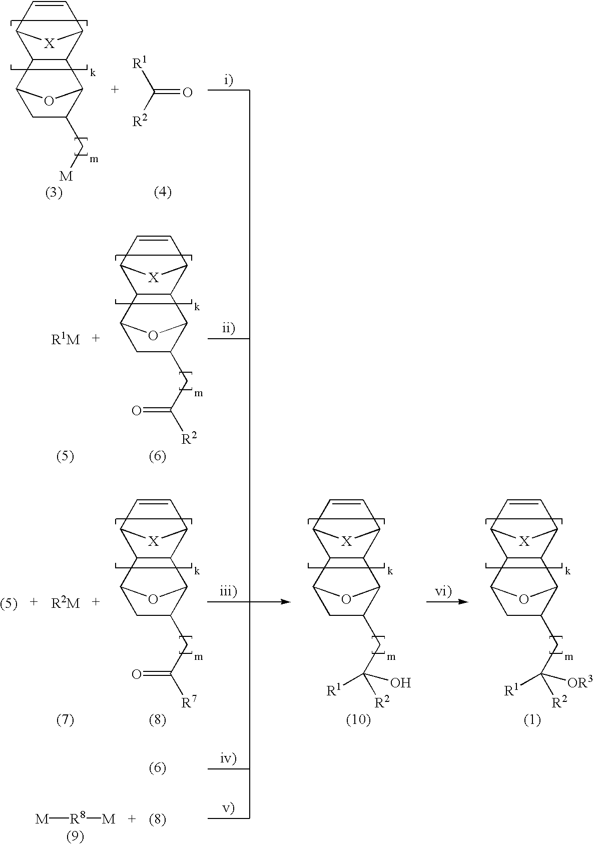

wherein, R to R³, X, k, and m have the same meanings as described above, R⁷ represents a halogen atom or OR⁹ in which R⁹ represents a methyl or ethyl group, M stands for Li, Na, K, MgP or ZnP, in which P represents a halogen atom, and R⁸ represents a divalent hydrocarbon group when R¹ and R² are coupled together to form an aliphatic hydrocarbon ring.

The synthesizing process of the alcohol compound (10), which corresponds to the first step of any one of the sub-steps i) to v) of the above-described reaction scheme will next be described specifically.

i) As a method of the synthesis, the intermediate alcohol compound (10) can be synthesized by the nucleophilic addition of an organometallic reagent (3) to a ketone compound (4).

The organometallic reagent (3) can be added preferably in an amount of 0.5 to 2.0 moles, especially 0.9 to 1.2 moles per mole of the ketone compound (4). Preferred examples of the solvent include ethers such as tetrahydrofuran, diethyl ether, di-n-butyl ether, and 1,4-dioxane, and hydrocarbons such as n-hexane, n-heptane, benzene, toluene, xylene and cumene. These solvents may be used either singly or in combination. The reaction temperature or reaction time varies, depending on the conditions. For example, when a Grignard reagent (in the case where M means MgP in the formula (3)) is used as an organometallic reagent, the reaction temperature may be set at −20 to 80° C., preferably 0 to 50° C. Completion of the reaction may be determined by gas chromatography (GC) or silica-gel thin-layer chromatography (TLC) so as to obtain a high-yield, but the reaction time is usually about 0.5 to 10 hours. The intermediate alcohol compound (10) is then obtained from the reaction mixture by the ordinarily-employed aqueous work-up technique. If necessary, the intermediate alcohol compound (10) can be purified in a conventional manner such as distillation or chromatography.

ii) As a second process, the intermediate alcohol compound (10) can be synthesized by the nucleophilic addition of an organometallic reagent (5) to a ketone compound (6).

The organometallic reagent (5) is added preferably in an amount of 1.0 to 3.0 moles, especially 1.1 to 1.5 moles per mole of the ketone compound (6). Preferred examples of the solvent include ethers such as tetrahydrofuran, diethyl ether, di-n-butyl ether, and 1,4-dioxane, and hydrocarbons such as n-hexane, n-heptane, benzene, toluene, xylene and cumene. These solvents may be used either singly or in combination. The reaction temperature or reaction time varies, depending on the conditions. For example, when a Grignard reagent (in the case where M means MgP in the formula (5)) is used as an organometallic reagent, the reaction temperature may be set at −20 to 80° C., preferably 0 to 50 ° C. Completion of the reaction may be determined by gas chromatography or silica-gel thin-layer chromatography so as to obtain a high-yield, but the reaction time is usually about 0.5 to 10 hours. The intermediate alcohol compound (10) is then obtained from the reaction mixture by the ordinarily-employed aqueous work-up technique. If necessary, it can be purified in a conventional manner such as distillation or chromatography.

iii) As a third method of the synthesis of intermediate alcohol compound, the intermediate alcohol compound (10) can be synthesized by the nucleophilic addition of organometallic reagents (5) and (7) to a carbonyl compound (8).

The organometallic reagents (5) and (7) may be added preferably in an amount of 2.0 to 5.0 moles, especially 2.0 to 3.0 moles per mole of the carbonyl compound (8). Preferred examples of the solvent include ethers such as tetrahydrofuran, diethyl ether, di-n-butyl ether, and 1,4-dioxane, and hydrocarbons such as n-hexane, n-heptane, benzene, toluene, xylene and cumene. These solvents may be used either singly or in combination. The reaction temperature or reaction time varies, depending on the conditions. For example, when Grignard reagents (in the case where M means MgP in the formulas (5) and (7)) are used as the organometallic reagents, the reaction temperature is set at 0 to 100° C., preferably 20 to 70° C. Completion of the reaction may be determined by gas chromatography or silica-gel thin-layer chromatography so as to obtain high-yield, but the reaction time is usually about 0.5 to 10 hours. The intermediate alcohol compound (10) is then obtained from the reaction mixture by the ordinarily-employed aqueous work-up technique. If necessary, it can be purified in a conventional manner such as distillation or chromatography.

iv) As a fourth method of the synthesis, the intermediate alcohol compound of the formula (10) wherein at least one of R¹ and R² represents a hydrogen atom can be synthesized by the reduction of the ketone compound (6).

Examples of the reducing agent usable here include complex hydrides such as lithium aluminum hydride, lithium borohydride, sodium borohydride, potassium borohydride and tetrabutylammonium borohydride, and substituted hydrides thereof such as lithium trialkoxyaluminum hydride, sodium di(methoxyethoxy)aluminum hydride, lithium triethylborohydride and sodium cyanoborohydride. The reducing agent may be added preferably in an amount of 0.1 to 3.0 moles, especially 0.3 to 1.0 mole per mole of the ketone compound (6). Preferred examples of the solvent include ethers such as tetrahydrofuran, diethyl ether, di-n-butyl ether, and 1,4-dioxane, and hydrocarbons such as n-hexane, n-heptane, benzene, toluene, xylene and cumene. These solvents may be used either singly or in combination. The reaction temperature or reaction time varies, depending on the conditions. For example, when lithium aluminum hydride is used as a reducing agent, the reaction temperature is set at 0 to 100° C., preferably 10 to 50° C. Completion of the reaction may be determined by gas chromatography or silica-gel thin-layer chromatography so as to obtain high-yield, but the reaction time is usually 0.5 to 10 hours. The target intermediate alcohol compound (10) is then obtained from the reaction mixture by the ordinarily-employed aqueous work-up technique. If necessary, it can be purified in a conventional manner such as distillation or chromatography.

v) As a fifth method of the synthesis, the intermediate alcohol compound of the formula (10) in which R¹ and R² are coupled together to form an aliphatic hydrocarbon ring, that is, the below-described partial structural formula (11) of the formula (10):

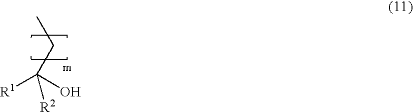

is represented by the following structural formula (12):

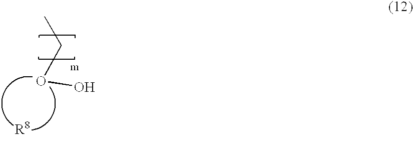

can be synthesized by the nucleophilic addition of an organometallic reagent (9) to a carbonyl compound (8).

The organometallic reagent (9) may be added preferably in an amount of 1.0 to 3.0 moles, especially 1.1 to 1.5 moles per mole of the carbonyl compound (8). Preferred examples of the solvent include ethers such as tetrahydrofuran, diethyl ether, di-n-butyl ether, and 1,4-dioxane, and hydrocarbons such as n-hexane, n-heptane, benzene, toluene, xylene and cumene. These solvents may be used either singly or in combination. The reaction temperature or reaction time varies, depending on the conditions. For example, when a Grignard reagent (in the case where M means MgP in the formula (9)) can be used as an organometallic reagent, the reaction temperature is set at 0 to 100° C., preferably 20 to 70° C. Completion of the reaction may be determined by gas chromatography or silica-gel thin-layer chromatography so as to obtain high-yield, but the reaction time is usually about 0.5 to 10 hours. The target tertiary alcoholic compound (1) is then available by the ordinarily-employed aqueous work-up technique. If necessary, it can be purified in a conventional manner such as distillation or chromatography.

vi) In the second step, the alcoholic hydroxyl group generated in the first stage is etherified or esterified. The reaction may readily proceed in a known manner. Acylation, for example, may preferably be conducted by simultaneously or successively adding, in a solventless manner or in a solvent such as methylene chloride, toluene or hexane, the intermediate alcohol compound, the corresponding acid anhydride which is the oxidant of the alcohol such as acetic anhydride or trifluoroacetic anhydride, and a base such as triethylene, pyridine or 4-dimethylaminopyridine. In this process, the reaction mixture may be cooled or heated as required.

The epoxy compound of the formula (2) corresponds to the epoxy compound of the formula (1) in which k and m each stands for 0. It may also be obtained by the above-described steps.

The present invention also provides a polymer prepared using the epoxy compound as a monomer. The polymer compound of the invention has one or more recurring units available from the epoxy compound of the formula (1).

Specific examples of the recurring unit available from the epoxy compound of the formula (1) include one or more recurring units represented by the following formulas (1a) and (2a):

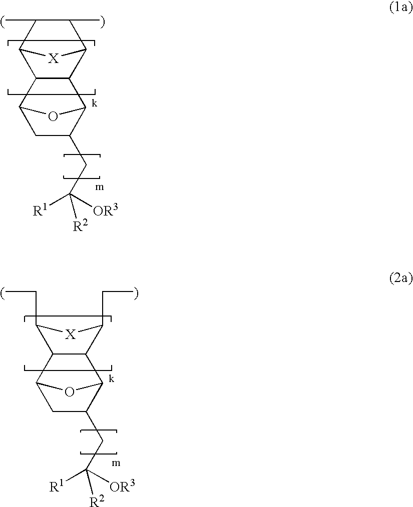

wherein, X, k, m and R¹ to R³ have the same meanings as described above.

The polymer compound of the invention may contain, in addition to the above-described recurring units represented by the formula (1a) or (2a), recurring units derived from the other monomer unit containing a double bond which can be used for polymerisation.

Examples of the recurring unit available from another monomer containing a polymerizable double bond include those represented by the following formulas (M1) to (M4):

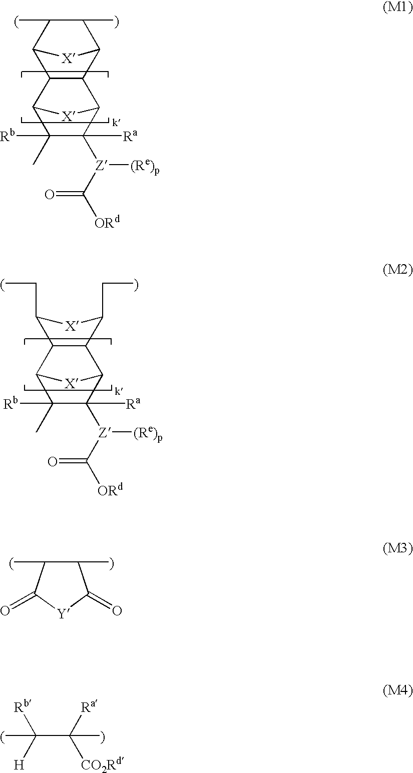

wherein, R^{a} and R^{a′} each independently represents a hydrogen atom, a methyl group or CH₂CO₂R^{c}; R^{b} and R^{b′} each independently represents a hydrogen atom, a methyl group or CO₂R^{c}; R^{c}s are the same or different between the groups R^{a} and R^{a′} and the groups R^{b} and R^{b′} and each represents a linear, branched or cyclic C₁₋₁₅ alkyl group; R^{d} and R^{d′} each independently represents an acid liable group; R^{e}s can be the same or different and each independently represents a halogen atom, a hydroxyl group, a linear, branched or cyclic C₁₋₁₅ alkoxy, acyloxy or alkylsulfonyloxy group, and a linear, branched or cyclic C₂₋₁₅ alkoxycarbonyloxy or alkoxyalkoxy group, in which hydrogen atoms on one or more constituent carbon atoms thereof may be partially or entirely substituted with one or more halogen atoms; X′s each independently represents CH₂, an oxygen atom or a sulfur atom, Y′ represents —O— or —(NR^{f})— in which R^{f} represents a hydrogen atom or a linear, branched or cyclic C₁₋₁₅ alkyl group, Z's are the same or different and each independently represents a single bond or a linear, branched or cyclic (p+2)-valent hydrocarbon group having 1 to 5 carbon atoms, with the proviso that when Z′ represents a hydrocarbon group, at least one methylene group may be substituted with an oxygen atom to form a chain-like or cyclic ether or two hydrogen atoms on a common carbon may be substituted with oxygen to form a ketone; k's each independently stands for 0 or 1; and ps each independently represents 0, 1 or 2.

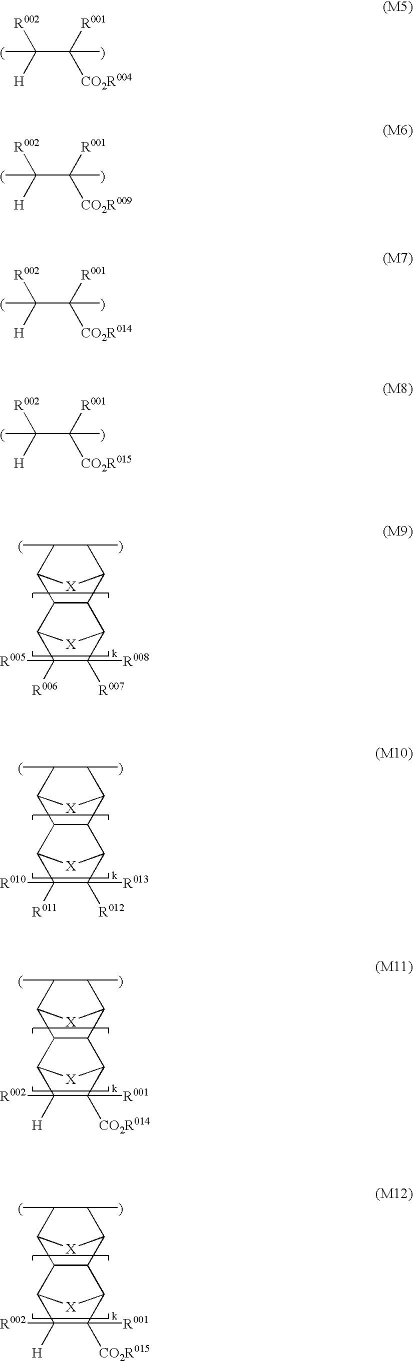

wherein, R⁰⁰¹s are the same or different and each independently represents a hydrogen atom, a methyl group, or CH₂CO₂R⁰⁰³, R⁰⁰²s are the same or different and each independently represents a hydrogen atom, a methyl group or CO₂R⁰⁰³, R⁰⁰³s are the same or different and each independently represents a linear, branched or cyclic C₁₋₁₅ alkyl group, R⁰⁰⁴s are the same or different and each independently represents a hydrogen atom or a monovalent C₁₋₁₅ hydrocarbon group having a carboxyl or hydroxyl group, at least one of R⁰⁰⁵ to R⁰⁰⁸ represents a monovalent C₁₋₁₅ hydrocarbon group having a carboxyl or hydroxyl group while the remaining groups each independently represents a hydrogen atom or a linear, branched or cyclic C₁₋₁₅ alkyl group, or R⁰⁰⁵ to R⁰⁰⁸ may be coupled together to form a ring, and in this case, at least one of R⁰⁰⁵ to R⁰⁰⁸ represents a divalent C₁₋₁₅ hydrocarbon group having a carboxyl or hydroxyl group, while the remaining groups each independently represents a single bond or a linear, branched or cyclic C₁₋₁₅ alkylene group, R⁰⁰⁹ represents a monovalent C₂₋₁₅ hydrocarbon group having at least one partial structure selected from ether, aldehyde, ketone, ester, carbonate, acid anhydride, amide and imide, at least one of R⁰¹⁰ to R⁰¹³ represents a monovalent C₂₋₁₅ hydrocarbon group having at least one partial structure selected from ether, aldehyde, ketone, ester, carbonate, acid anhydride, amide and imide, while the remaining groups each independently represents a hydrogen atom or a linear, branched or cyclic C₁₋₁₅ alkyl group, or R⁰¹⁰ to R⁰¹³ may be coupled together to form a ring, and in this case, at least one of R⁰¹⁰ to R⁰¹³ represents a divalent C₁₋₁₅ hydrocarbon group having at least one partial structure selected from ether, aldehyde, ketone, ester, carbonate, acid anhydride, amide and imide, while the remaining groups each independently represents a single bond or a linear, branched or cyclic C₁₋₁₅ alkylene group, R⁰¹⁴ s are the same or different and each independently represents a polycyclic C₇₋₁₅ hydrocarbon group or an alkyl group containing a polycyclic hydrocarbon group, R⁰¹⁵s are the same or different and each independently represents an acid-labile group, Xs each independently represents CH₂, or an oxygen or sulfur atom, and ks each independently stands for 0 or 1.

In the above-described formulas, R^{a} and R^{a′} each independently represents a hydrogen atom, a methyl group or CH₂CO₂R^{c}. Specific examples of R^{c} will be described later. R^{b} and R^{b′} each independently represents a hydrogen atom, a methyl group or CO₂R^{c}.

R^{c}s are the same or different between the groups R^{a} and R^{a′} and the groups R^{b} and R^{b′} and each represents a linear, branched or cyclic C₁₋₁₅ alkyl group. Specific examples include methyl, ethyl, propyl, isopropyl, n-butyl, sec-butyl, tert-butyl, tert-amyl, n-pentyl, n-hexyl, cyclopentyl, cyclohexyl, ethylcyclopentyl, butylcyclopentyl, ethylcyclohexyl, butylcyclohexyl, adamantyl, ethyladamantyl and butyladamantyl. R^{d} and R^{d′} are the same or different and each independently represents an acid liable group and specific examples of the group will be described later.

R^{e}s are the same or different and each independently represents a halogen atom, a hydroxyl group, a linear, branched or cyclic C₁₋₁₅ alkoxy, acyloxy or alkylsulfonyloxy group, and a linear, branched or cyclic C₂₋₁₅ alkoxycarbonyloxy or alkoxyalkoxy group, in which hydrogen atoms on one or more constituent carbon atoms thereof may be partially or entirely substituted with one or more halogen atoms. Specific examples include fluorine, chlorine, bromine, hydroxyl, methoxy, ethoxy, propoxy, isopropoxy, n-butoxy, sec-butoxy, tert-butoxy, tert-amyloxy, n-pentoxy, n-hexyloxy, cyclopentyloxy, cyclohexyloxy, ethylcyclopentyloxy, butylcyclopentyloxy, ethylcyclohexyloxy, butylcyclohexyloxy, adamantyloxy, ethyladamantyloxy, butyladamantyloxy, formyloxy, acetoxy, ethylcarbonyloxy, pivaloyloxy, methanesulfonyloxy, ethanesulfonyloxy, n-butanesulfonyloxy, trifluoroacetoxy, trichloroacetoxy, 3,3,3-trifluoroethylcarbonyloxy, methoxymethoxy, 1-ethoxyethoxy, 1-ethoxypropoxy, 1-tert-butoxyethoxy, 1-cyclohexyloxyethoxy, 2-tetrahydrofuranyloxy, 2-tetrahydropyranyloxy, methoxycarbonyloxy, ethoxycarbonyloxy and tert-butoxycarbonyloxy.

X′s are the same or different and each independently represents CH₂, an oxygen atom or a sulfur atom. Y′ represents —O— or —(NR^{f})— in which R^{f} represents a hydrogen atom or a linear, branched or cyclic C₁₋₁₅ alkyl group, and Specific examples of such an alkyl group include methyl, ethyl, propyl, isopropyl, n-butyl, sec-butyl, tert-butyl, tert-amyl, n-pentyl, n-hexyl, cyclopentyl, cyclohexyl, ethylcyclopentyl, butylcyclopentyl, ethylcyclohexyl, butylcyclohexyl, adamantyl, ethyladamantyl, and butyladamantyl.

Z′s are the same or different and each independently represents a single bond or a linear, branched or cyclic (p+2)-valent hydrocarbon group having 1 to 5 carbon atoms, with the proviso that when Z′ represents a hydrocarbon group, at least one methylene group may be substituted with an oxygen atom to form a chain-like or cyclic ether. In case of p=0, specific examples of Z′ includes methylene, ethylene, trimethylene, tetramethylene, pentamethylene, 1,2-propanediyl, 1,3-butanediyl, 1-oxo-2-oxapropane-1,3-diyl, and 3-methyl-1-oxo-2-oxabutane-1,4-diyl. In case of p≠0, exemplary Z′ includes (p+2)-valent groups obtained by eliminating p hydrogen atoms from the above-exemplified groups for p=0. Two hydrogen atoms on one carbon may be substituted with oxygen to form a ketone. In any one of the above-described formulas, k stands for 0 or 1, while p represents 0, 1 or 2.

As R^{d} or R^{d}′, various acid-labile groups can be employed, but specific examples include groups represented by the following formulas (L1) to (L4), tertiary alkyl groups having 4 to 20, preferably 4 to 15 carbon atoms, trialkylsilyl groups having, as each of alkyl moieties, a C₁₋₆ alkyl group, and C₄₋₂₀ oxoalkyl groups.

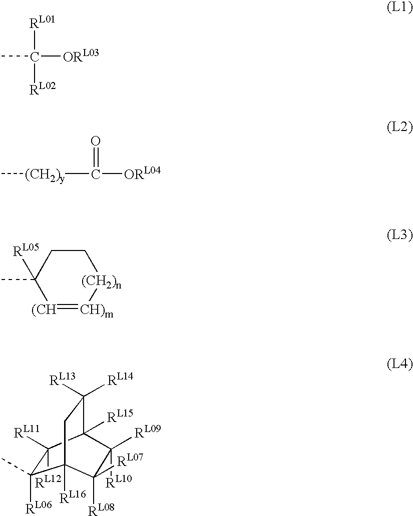

In these formulas, broken lines denotes a free valence bond (which will equally apply hereinafter). R^{L01} and R^{L02} are the same or different and each independently represents a hydrogen atom or a linear, branched or cyclic alkyl group having 1 to 18, preferably 1 to 10 carbon atoms. Specific examples include methyl, ethyl, propyl, isopropyl, n-butyl, sec-butyl, tert-butyl, cyclopentyl, cyclohexyl, 2-ethylhexyl, and n-octyl.

R^{L03} s each independently represents a monovalent hydrocarbon group having 1 to 18, preferably 1 to 10 carbon atoms, which may contain a hetero atom such as oxygen. Examples include linear, branched or cyclic alkyl groups and these groups in which some hydrogen atoms have been substituted by hydroxyl, alkoxy, oxo, amino or alkylamino groups. Specific examples include the below-described substituted alkyl groups.

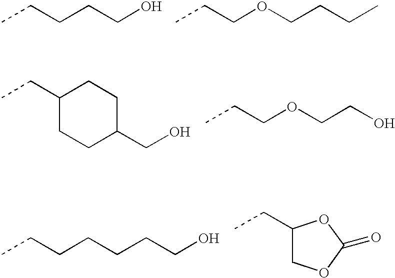

A pair of R^{L01} and R^{L02}, R^{L01} and R^{L03}, or R^{L02} and R^{L03} may be coupled together to form a ring. When they form a ring, R^{L01}, R^{L02} and R^{L03} are the same or different and each represents a linear or branched alkylene group having 1 to 18, preferably 1 to 10 carbon atoms.

R^{L04} represents a tertiary alkyl group having 4 to 20, preferably 4 to 15 carbon atoms, a trialkylsilyl group having, as each alkyl moiety, a C₁₋₆ alkyl group, a C₄₋₂₀ oxoalkyl group, or a group of formula (LI). Examples of the tertiary alkyl group include tert-butyl, tert-amyl, 1,1-diethylpropyl, 2-cyclopentylpropan-2-yl, 2-cyclohexylpropan-2-yl, 2-(bicyclo[2.2.1]heptan-2-yl)propan-2-yl, 2-(adamantan-1-yl)propan-2-yl, 1-ethylcyclopentyl, 1-butylcyclopentyl, 1-ethylcyclohexyl, 1-butylcyclohexyl, 1-ethyl-2-cyclopentenyl, 1-ethyl-2-cyclohexenyl, 2-methyl-2-adamantyl, and 2-ethyl-2-adamantyl. Examples of the trialkylsilyl group include trimethylsilyl, triethylsilyl, and dimethyl-tert-butylsilyl, while those of the oxoalkyl group include 3-oxocyclohexyl, 4-methyl-2-oxooxan-4-yl, and 5-methyl-2-oxooxolan-5-yl.

Letter y stands for an integer of 0 to 6.

R^{L05} represents a monovalent C₁₋₈ hydrocarbon group which may contain a hetero atom or a substituted or unsubstituted C₆₋₂₀ aryl group. Examples of the monovalent hydrocarbon group which may contain a hetero atom include linear, branched or cyclic alkyl groups such as methyl, ethyl, propyl, isopropyl, n-butyl, sec-butyl, tert-butyl, tert-amyl, n-pentyl, n-hexyl, cyclopentyl, and cyclohexyl, and groups obtained by substituting some hydrogen atoms of the above exemplified groups with hydroxyl, alkoxy, carboxy, alkoxycarbonyl, oxo, amino, alkylamino, cyano, mercapto, alkylthio, or sulfo group. Examples of the substituted or unsubstituted aryl group include phenyl, methylphenyl, naphthyl, anthryl, phenanthryl, and pyrenyl.

Letter q stands for 0 or 1, r stands for any one of 0, 1, 2 and 3, and they satisfy the following equation: 2q+r=2 or 3.

R^{L06} represents a monovalent C₁₋₈ hydrocarbon group which may have a hetero atom or a substituted or unsubstituted C₆₋₂₀ aryl group. Examples of these groups are similar to those described above for R_{L05}.

R^{L07} to R^{L16} each independently represents a hydrogen atom or a monovalent C₁₋₁₅ hydrocarbon group which may contain a hetero atom. Specific examples include linear, branched or cyclic alkyl groups such as methyl, ethyl, propyl, isopropyl, n-butyl, sec-butyl, tert-butyl, tert-amyl, n-pentyl, n-hexyl, n-octyl, n-nonyl, n-decyl, cyclopentyl, cyclohexyl, cyclopentylmethyl, cyclopentylethyl, cyclopentylbutyl, cyclohexylmethyl, cyclohexylethyl and cyclohexylbutyl, and groups obtained by substituting some hydrogen atoms of the above-exemplified alkyl groups by hydroxyl, alkoxy, carboxy, alkoxycarbonyl, oxo, amino, alkylamino, cyano, mercapto, alkylthio, or sulfo groups. R^{L07} to R^{L06} (for example, a pair of R^{L07} and R^{L08}, R^{L07} and R^{L09}, R^{L08} and R^{L10}, R^{L09} and R^{L10}, R^{L11} and R^{L12}, or R^{L13} and R^{L14}) may be coupled together to form a ring. In such a case, R^{L07} to R^{L16} are the same or different and each represents a divalent C₁₋₁₅ hydrocarbon group which may contain a hetero atom. Specific examples include groups obtained by removing a hydrogen atom from the above-described monovalent hydrocarbon groups. Two of R^{L07} to R^{L16} which are bonded to adjacent carbon atoms (for example, a pair of R^{L07} and R^{L09}, R^{L09} and R^{L05}, or R^{L03} and R^{L15}) may be coupled directly to form a double bond.

Of the acid-labile groups of the formula (L1), examples of the linear or branched ones include the following groups.

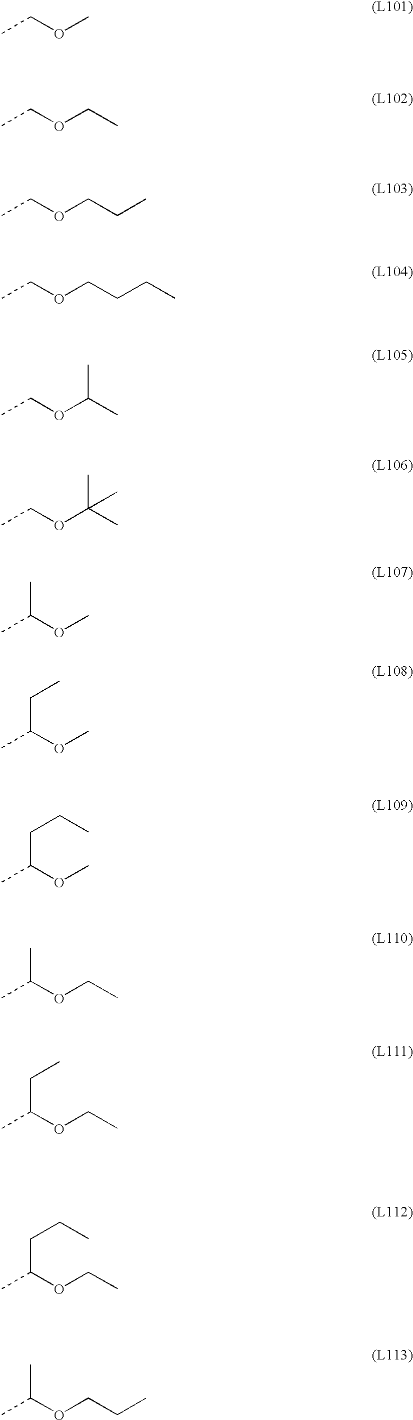

Of the above-described acid-labile groups of the formula (L1), the cyclic ones include tetrahydrofuran-2-yl, 2-methyltetrahydrofuran-2-yl, tetrahydropyran-2-yl, and 2-methyltetrahydropyran-2-yl.

Specific examples of the acid-labile groups of the formula (L2) include tert-butoxycarbonyl, tert-butoxycarbonylmethyl, tert-amyloxycarbonyl, tert-amyloxycarbonylmethyl, 1,1-diethylpropyloxycarbonyl, 1,1-diethylpropyloxycarbonylmethyl, 1-ethylcyclopentyloxycarbonyl, 1-ethylcyclopentyloxycarbonylmethyl, 1-ethyl-2-cyclopentenyloxycarbonyl, 1-ethyl-2-cyclopentenyloxycarbonylmethyl, 1-ethoxyethoxycarbonylmethyl, 2-tetrahydropyranyloxycarbonylmethyl, and 2-tetrahydrofuranyloxycarbonylmethyl groups.

Examples of the acid-labile groups of the formula (L3) include 1-methylcyclopentyl, 1-ethylcyclopentyl, 1-n-propylcyclopentyl, 1-isopropylcyclopentyl, 1-n-butylcyclopentyl, 1-sec-butylcyclopentyl, 1-cyclohexylcyclopentyl, 1-(4-methoxy-n-butyl)cyclopentyl, 1-methylcyclohexyl, 1-ethylcyclohexyl, 3-methyl-1-cyclopenten-3-yl, 3-ethyl-1-cyclopenten-3-yl, 3-methyl-1-cyclohexen-3-yl, and 3-ethyl-1-cyclohexen-3-yl.

Examples of the acid-labile groups of the formula (L4) include the following groups:

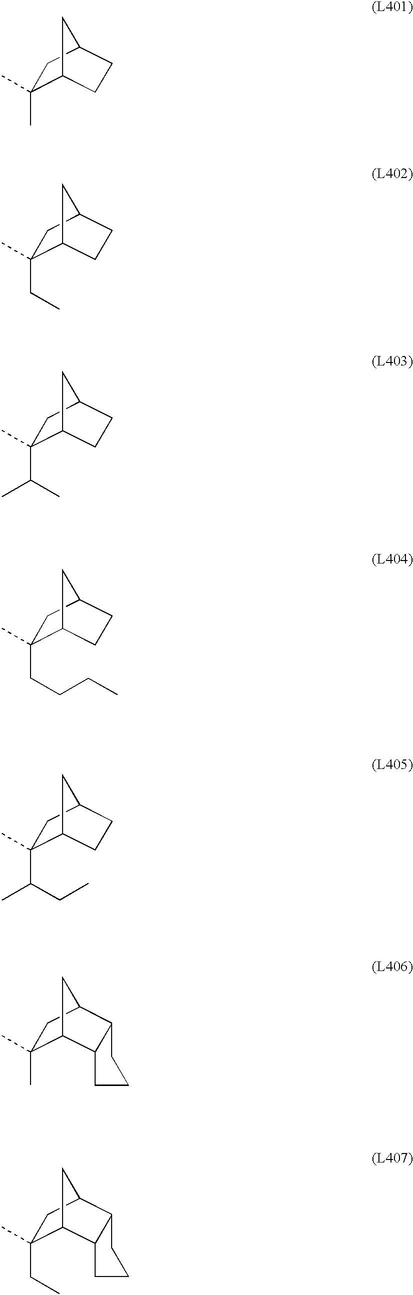

Examples of the tertiary C₄₋₂₀ alkyl groups, trialkylsilyl groups having, as each of the alkyl moieties, a C₁₋₆ alkyl group and C₄₋₂₀ oxoalkyl groups are similar to those exemplified as R^{L04}.

R⁰⁰¹s are the same or different and each represents a hydrogen atom, a methyl group, or CH₂CO₂R⁰⁰³. Specific examples of R⁰⁰³ will be described below. R⁰⁰²s are the same or different and each represents a hydrogen atom, a methyl group, or CO₂R⁰⁰³. R⁰⁰³s are the same or different and each represents a linear, branched or cyclic C₁₋₁₅ alkyl group. Examples include methyl, ethyl, propyl, isopropyl, n-butyl, sec-butyl, tert-butyl, tert-amyl, n-pentyl, n-hexyl, cyclopentyl, cyclohexyl, ethylcyclopentyl, butylcyclopentyl, ethylcyclohexyl, butylcyclohexyl, adamantyl, ethyladamantyl, and butyladamantyl.

R⁰⁰⁴ represents a hydrogen atom or a monovalent C₁₋₁₅ hydrocarbon group having a carboxyl or hydroxyl group. Specific examples include hydrogen atom, and carboxyethyl, carboxybutyl, carboxycyclopentyl, carboxycyclohexyl, carboxynorbornyl, carboxyadamantyl, hydroxyethyl, hydroxybutyl, hydroxycyclopentyl, hydroxycyclohexyl, hydroxynorbornyl, and hydroxyadamantyl groups.

At least one of R⁰⁰⁵ to R⁰⁰⁸ represents a monovalent C₁₋₁₅ hydrocarbon group having a carboxyl or hydroxyl group while the remaining groups each independently represents a hydrogen atom or a linear, branched or cyclic C₁₋₁₅ alkyl group. Examples of the C₁₋₁₅ monovalent hydrocarbon group having a carboxyl or hydroxyl group include carboxy, carboxymethyl, carboxyethyl, carboxybutyl, hydroxymethyl, hydroxyethyl, hydroxybutyl, 2-carboxyethoxycarbonyl, 4-carboxybutoxycarbonyl, 2-hydroxyethoxycarbonyl, 4-hydroxybutoxycarbonyl, carboxycyclopentyloxycarbonyl, carboxycyclohexyloxycarbonyl, carboxynorbornyloxycarbonyl, carboxyadamantyloxycarbonyl, hydroxycyclopentyloxycarbonyl, hydroxycyclohexyloxycarbonyl, hydroxynorbornyloxycarbonyl, and hydroxyadamantyloxycarbonyl. Examples of the linear, branched or cyclic C₁₋₁₅ alkyl group are similar to those exemplified as R^{b}. Alternativelyl, R⁰⁰⁵ to R⁰⁰⁸ may be coupled together to form a ring, and in such a case, at least one of R⁰⁰⁵ to R⁰⁰⁸ represents a divalent C₁₋₁₅ hydrocarbon group having a carboxyl or hydroxyl group, while the remaining groups each independently represents a single bond or a linear, branched or cyclic C₁₋₁₅ alkylene group. Specific examples of the divalent C₁₋₁₅ hydrocarbon group having a carboxyl or hydroxyl group include groups obtained by removing one hydrogen atom from the above-described monovalent C₁₋₁₅ hydrocarbon groups having a carboxyl or hydroxyl group. Specific examples of the linear, branched or cyclic C₁₋₁₅ alkylene group include groups obtained by removing one hydrogen atom from the groups exemplified above as R^{b}.

R⁰⁰⁹s represent a monovalent C₂₋₁₅ hydrocarbon group containing at least one partial structure selected from ether, aldehyde, ketone, ester, carbonate, acid anhydride, amide and imide. Specific examples include methoxymethyl, methoxyethoxyethyl, 2-oxooxolan-3-yl, 2-oxooxolan-4-yl, 4,4-dimethyl-2-oxooxolan-3-yl, 4-methyl-2-oxooxan-4-yl, 2-oxo-1,3-dioxolan-4-ylmethyl, and 5-methyl-2-oxooxolan-5-yl.

At least one of R⁰¹⁰ to R⁰¹³ represents a monovalent C₂₋₁₅ hydrocarbon group containing at least one partial structure selected from ether, aldehyde, ketone, ester, carbonate, acid anhydride, amide and imide, while the remaining groups each independently represents a hydrogen atom or a linear, branched or cyclic C₁₋₁₅ alkyl group. Examples of the monovalent C₂₋₁₅ hydrocarbon group containing at least one partial structure selected from ether, aldehyde, ketone, ester, carbonate, acid anhydride, amide and imide include methoxymethyl, methoxymethoxymethyl, formyl, methylcarbonyl, formyloxy, acetoxy, pivaloyloxy, formyloxymethyl, acetoxymethyl, pivaloyloxymethyl, methoxycarbonyl, 2-oxooxolan-3-yloxycarbonyl, 4,4-dimethyl-2-oxooxolan-3-yloxycarbonyl, 4-methyl-2-oxooxan-4-yloxycarbonyl, 2-oxo-1,3-dioxolan-4-ylmethyloxycarbonyl, and 5-methyl-2-oxooxolan-5-yloxycarbonyl. Examples of the linear, branched or cyclic C₁₋₁₅ alkyl group are similar to those exemplified above as R⁰⁰³. R⁰¹⁰ to R⁰¹³ may be coupled together to form a ring, and in such a case, at least one of R⁰¹⁰ to R⁰¹³ represents a divalent C₁₋₁₅ hydrocarbon group containing at least one partial structure selected from ether, aldehyde, ketone, ester, carbonate, acid anhydride, amide and imide, while the remaining groups each independently represents a single bond or a linear, branched or cyclic C₁₋₁₅ alkylene group. Examples of the divalent C₁₋₁₅ hydrocarbon group containing at least one partial structure selected from ether, aldehyde, ketone, ester, carbonate, acid anhydride, amide and imide include 2-oxapropane-1,3-diyl, 1,1-dimethyl-2-oxapropane-1,3-diyl, 1-oxo-2-oxapropane-1,3-diyl, 1,3-dioxo-2-oxapropane -1,3-diyl, 1-oxo-2-oxabutane-1,4-diyl and 1,3-dioxo-2-oxabutane-1,4-diyl, as well as groups obtained by removing one hydrogen group from the groups exemplified as the monovalent C₁₋₁₅ hydrocarbon group containing at least one partial structure selected from ether, aldehyde, ketone, ester, carbonate, acid anhydride, amide and imide. Examples of the linear, branched or cyclic C₁₋₁₅ alkylene group include groups obtained by removing one hydrogen atom from the groups exemplified above as R⁰⁰³.

R⁰¹⁴s are the same or different and each represents a polycyclic C₇₋₁₅ hydrocarbon group or an alkyl group containing a polycyclic hydrocarbon group. Specific examples include norbornyl, bicyclo[3.3.1]nonyl, tricyclo[5.2.1.0^{2,6}]decyl, adamantyl, ethyladamantyl, butyladamantyl, norbornylmethyl, and adamantylmethyl groups. R⁰¹⁵ s are the same or different and each represents an acid-labile group. Examples are similar to those exemplified above as R^{d} or R^{d′}.

Xs each independently represents CH₂ or an oxygen atom. Letters k each independently represents 0 or 1.

The polymer compound of the present invention may have a recurring unit derived from the other monomer having a carbon-carbon double bond. Examples include, but not limited to, substituted acrylates such as methyl methacrylate, methyl crotonate, dimethyl maleate, and dimethyl itaconate, unsaturated carboxylic acids such as maleic acid, fumaric acid and itaconic acid, substituted norbornenes such as norbornene, methyl norbornene-5-carboxylate, and unsaturated acid anhydrides such as itaconic anhydride. The polymer compound may contain a further monomer having a carbon-carbon double bond, which has not been described above.

The polymer compound of the present invention has preferably a weight-average molecular weight, as measured by gel permeation chromatography (GPC) using polystyrene as a standard, of 1,000 to 500,000, preferably 3,000 to 100,000. Outside this range, a marked deterioration in etching resistance or lowering in resolution owing to loss of a substantial difference in a dissolution rate before and after exposure may occur.

In the polymer compound of the invention, the preferred proportion of recurring units available from respective monomers falls within the following range (mol %), though not limited thereto.

(I) If the polymer has recurring units of the formula (1a) and recurring units of the formula (M1), the polymer may have:

(i) 1 to 90%, preferably 5 to 80%, more preferably 10 to 70% of the recurring units of the formula (1a),

(ii) 1 to 90%, preferably 5 to 80%, more preferably 10 to 70% of the recurring units of the formula (M1),

(iii) 0 to 50%, preferably 0 to 40%, more preferably 0 to 30% of the recurring units of one or a combination of the formulas (M9) to (M12), and

(iv) 0 to 50%, preferably 0 to 40%, more preferably 0 to 30% of recurring units derived from the other monomer.

(II) If the polymer has recurring units of formula (1a), recurring units of the formula (M1) and recurring units of the formula (M3), the polymer may have:

(i) 1 to 49%, preferably 3 to 45%, more preferably 5 to 40% of the recurring units of the formula (1a),

(ii) 1 to 49%, preferably 3 to 45%, more preferably 5 to 40% of the recurring units of the formula (M1),

(iii) 50 mol % of the recurring units of the formula (M3),

(iv) 0 to 25%, preferably 0 to 20%, more preferably 0 to 15% of the recurring units of one or more of the formulas (M9) to (M12), and

(v) 0 to 25%, preferably 0 to 20%, more preferably 0 to 15% of the recurring units derived from the other monomer.

(III) If the polymer compound has recurring units of formula (1a); recurring units of the formula (M4); or recurring units of the formula (M1) and recurring units of the formula (M4), and recurring units of the formula (M3), the polymer may have:

(i) 1 to 49%, preferably 3 to 45%, more preferably 5 to 40% of the recurring units of the formula (1a),

(ii) 0 to 40%, preferably 0 to 35%, more preferably 0 to 30% of the recurring units of the formula (M1),

(iii) 1 to 80%, preferably 1 to 70%, more preferably 1 to 50% of the recurring units of the formula (M4),

(iv) 1 to 49%, preferably 5 to 45%, more preferably 10 to 40% of the recurring units of the formula (M3),

(v) 0 to 25%, preferably 0 to 20%, more preferably 0 to 15% of one or more recurring units selected from those of the formulas (M5) to (M12), and

(vi) 0 to 25%, preferably 0 to 20%, more preferably 0 to 15% of the recurring units derived from the other monomer.

(IV) If the polymer has recurring units of the formula (2a) and recurring units of the formula (M2), the polymer may have:

(i) 1 to 90%, preferably 5 to 80%, more preferably 10 to 70% of the recurring units of the formula (2a),

(ii) 1 to 90%, preferably 5 to 80%, more preferably 10 to 70% of the recurring units of the formula (M2),

(iii) 0 to 50%, preferably 0 to 40%, more preferably 0 to 30% of one or more recurring units selected from those of the formulas (M13) to (M16), and

(iv) 0 to 50%, preferably 0 to 40%, more preferably 0 to 30% of the recurring units derived from the other monomer.

The polymer compound of the invention is prepared by copolymerization of the compound of the formula (1) as a first monomer and a compound having a polymerizable double bond as another monomer.

A variety of copolymerization reactions can be given as a reaction for preparing the polymer of the invention. Radical polymerization, anionic polymerization and coordination polymerization are preferred.

Radical polymerization is preferably effected (a) in a solvent, for example, a hydrocarbon such as benzene, an ether such as tetrahydrofuran, an alcohol such as ethanol, or a ketone such as methyl isobutyl ketone; (b) in the presence of a polymerization initiator, for example, an azo compound such as 2,2′-azobisisobutyronitrile, or a peroxide such as benzoyl peroxide or lauroyl peroxide, (c) at a reaction temperature maintained at about 0 to 100° C., (e) for about 0.5 to 48 hours. Reaction conditions outside the above-described range are however not excluded.

Anionic polymerization is preferably effected (a) in a solvent, for example, a hydrocarbon such as benzene, an ether such as tetrahydrofuran, or liquid ammonia, (b) in the presence of a polymerization initiator, for example, a metal such as sodium or potassium, an alkyl metal such as n-butyl lithium or sec-butyl lithium, ketyl, or a Grignard reagent, (c) at a reaction temperature of about −78° C. to 0° C., (d) for about 0.5 hour to 48 hours, by using (e) a terminator, for example, a proton-donative compound such as methanol, a halide such as methyl iodide, or an electrophilic compound. Reaction conditions outside the described range are however not excluded.

Coordination polymerization is preferably effected (a) in a solvent, for example, a hydrocarbon such as n-heptane or toluene, (b) in the presence of a catalyst, for example, a Ziegler-Natta catalyst made of a transition metal such as titanium and an alkyl aluminum, a Phillips catalyst having chromium and nickel compounds borne on a metal oxide, and an olefin-metathesis mixed catalyst as typified by tungsten-rhenium mixed catalyst, (c) at a temperature maintained at about 0° C. to 100° C., (d) for a reaction time of about 0.5 hour to 48 hours. Reaction conditions outside the described range are not, however, excluded.

The polymer compound of the invention is useful as a base polymer for resist materials. The invention provides a resist material, particularly, a chemically amplified positive resist material containing the polymer compound.

The resist material of the invention may contain, in addition to the base polymer containing the polymer of the invention, a compound capable of generating an acid when it is exposed to high energy beams or electron beams (which compound will hereinafter be called “acid generator”) and an organic solvent, and if necessary another component. Examples of the acid generator usable in the invention include:

(i) onium salts of the below-described formula (P1a-1), (P1a-2) or (P1b),

(ii) diazomethane derivatives of the below-described formula (P2),

(iii) glyoxime derivatives of the below-described formula (P3),

(iv) bissulfone derivatives of the below-described formula (P4),

(v) sulfonic acid esters of an N-hydroxyimide compound, said esters being represented by the below-described formula (P5),

(vi) 3-ketosulfonic acid derivatives,

(vii) disulfone derivatives,

(viii) nitrobenzyl sulfonate derivatives, and

(ix) sulfonic acid ester derivatives.

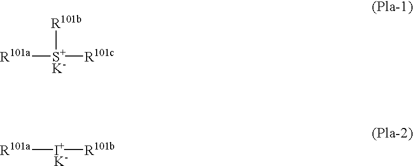

wherein, R^{101a}, R^{101b}, and R^{101c} are the same or different and each independently represents a linear, branched or cyclic C₁₋₁₂ alkyl, alkenyl, oxoalkyl or oxoalkenyl group, a C₆₋₂₀ aryl group, or a C₇₋₁₂ aralkyl or aryloxoalkyl group, wherein one or more hydrogen atoms may be partially or entirely substituted by one or more alkoxy groups; or R^{101b} and R^{101c} may be coupled together to form a ring, with the proviso that when R^{101b} and R^{101c} form a ring, they are the same or different and each represents a C₁₋₆ alkylene group; and K⁻ represents a non-nucleophilic counter ion.

R^{101a}, R^{101b}, and R^{101c} are the same or different. Specific examples of the alkyl group include methyl, ethyl, propyl, isopropyl, n-butyl, sec-butyl, tert-butyl, pentyl, hexyl, heptyl, octyl, cyclopentyl, cyclohexyl, cycloheptyl, cyclopropylmethyl, 4-methylcyclohexyl, cyclohexylmethyl, norbornyl, and adamantyl. Examples of the alkenyl group include vinyl, allyl, propenyl, butenyl, hexenyl, and cyclohexenyl. Examples of the oxoalkyl group include 2-oxocyclopentyl and 2-oxocyclohexyl as well as 2-oxopropyl, 2-cyclopentyl-2-oxoethyl, 2-cyclohexyl-2-oxoethyl, and 2-(4-methylcyclohexyl)-2-oxoethyl. Examples of the aryl group include phenyl and naphthyl; alkoxyphenyl groups such as p-methoxyphenyl, m-methoxyphenyl, o-methoxyphenyl, ethoxyphenyl, p-tert-butoxyphenyl, and m-tert-butoxyphenyl; alkylphenyl groups such as 2-methylphenyl, 3-methylphenyl, 4-methylphenyl, ethylphenyl, 4-tert-butylphenyl, 4-butylphenyl, and dimethylphenyl; alkylnaphthyl groups such as methylnaphthyl and ethylnaphthyl; alkoxynaphthyl groups such as methoxynaphthyl and ethoxynaphthyl; dialkylnaphthyl groups such as dimethylnaphthyl and diethylnaphthyl; and dialkoxynaphthyl groups such as dimethoxynaphthyl and diethoxynaphthyl. Examples of the aralkyl group include benzyl, phenylethyl, and phenethyl. Examples of the aryloxoalkyl group include 2-aryl-2-oxoethyl groups such as 2-phenyl-2-oxoethyl, 2-(1-naphthyl)-2-oxoethyl, and 2-(2-naphthyl)-2-oxoethyl. Examples of the non-nucleophilic counter ion represented by K⁻ include halide ions such as chloride and bromide ions, fluoroalkylsulfonates such as triflate, 1,1,1-trifluoroethanesulfonate, and nonafluorobutanesulfonate, arylsulfonates such as tosylate, benzenesulfonate, 4-fluorobenzenesulfonate, and 1,2,3,4,5-pentafluorobenzenesulfonate, and alkylsulfonates such as mesylate and butanesulfonate.

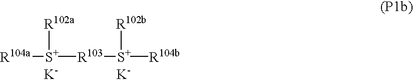

wherein, R^{102a} and R^{102b} are the same or different and each represents a linear, branched or cyclic C₁₋₈ alkyl group, R¹⁰³ represents a linear, branched or cyclic C₁₋₁₀ alkylene group, R^{104a} and R^{104b} are the same or different and each represents 2-oxoalkyl groups having 3 to 7 carbon atoms, and K⁻ represents a non-nucleophilic counter ion.

Specific examples of R^{102a} and R^{102b} include methyl, ethyl, propyl, isopropyl, n-butyl, sec-butyl, tert-butyl, pentyl, hexyl, heptyl, octyl, cyclopentyl, cyclohexyl, cyclopropylmethyl, 4-methylcyclohexyl, and cyclohexylmethyl. Examples of R¹⁰³ include methylene, ethylene, propylene, butylene, pentylene, hexylene, heptylene, octylene, nonylene, 1,4-cyclohexylene, 1,2-cyclohexylene, 1,3-cyclopentylene, 1,4-cyclooctylene, and 1,4-cyclohexanedimethylene. Examples of R^{104a} and R^{104b} include 2-oxopropyl, 2-oxocyclopentyl, 2-oxocyclohexyl, and 2-oxocycloheptyl. Examples of the counter ion represented by K⁻ are similar to those described in the formula (P1a-1) and (P1a-2).

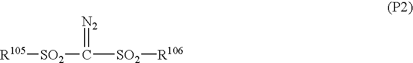

wherein, R¹⁰⁵ and R¹⁰⁶ are the same or different and each represents a linear, branched or cyclic C₁₋₁₂ alkyl or alkyl hydride group, a C₆₂₀ aryl or halogenated aryl group, or a C₇₋₁₂ aralkyl group.

Examples of the alkyl group as R¹⁰⁵ or R¹⁰⁶ include methyl, ethyl, propyl, isopropyl, n-butyl, sec-butyl, tert-butyl, pentyl, hexyl, heptyl, octyl, amyl, cyclopentyl, cyclohexyl, cycloheptyl, norbornyl, and adamantyl. Examples of the alkyl halide group include trifluoromethyl, 1,1,1-trifluoroethyl, 1,1,1-trichloroethyl, and nonafluorobutyl. Exemplary aryl groups include phenyl; alkoxyphenyl groups such as p-methoxyphenyl, m-methoxyphenyl, o-methoxyphenyl, ethoxyphenyl, p-tert-butoxyphenyl, and m-tert-butoxyphenyl, and alkylphenyl groups such as 2-methylphenyl, 3-methylphenyl, 4-methylphenyl, ethylphenyl, 4-tert-butylphenyl, 4-butylphenyl, and dimethylphenyl. Examples of the halogenated aryl group include fluorophenyl, chlorophenyl, and 1,2,3,4,5-pentafluorophenyl. Examples of the aralkyl group include benzyl and phenethyl.

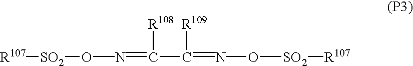

wherein, R¹⁰⁷, R¹⁰⁸, and R¹⁰⁹ are the same or different and each represents a linear, branched or cyclic alkyl or alkyl hydride group having 1 to 12 carbon atoms, an aryl or halogenated aryl group having 6 to 20 carbon atoms, or a C₇₋₁₂ aralkyl group, or R¹⁰⁸ and R¹⁰⁹ may be coupled together to form a cyclic structure with the proviso that when R¹⁰⁸ and R¹⁰⁹ form the cyclic structure, they each represents a linear or branched C₁₋₆ alkylene group.

Examples of the alkyl, alkyl hydride, aryl, aryl hydride, and aralkyl groups represented by R¹⁰⁷, R¹⁰⁸ or R¹⁰⁹ are similar to those described as R¹⁰⁵ and R¹⁰⁶. Examples of the alkylene group represented by R¹⁰⁸ or R¹⁰⁹ include methylene, ethylene, propylene, butylene, and hexylene.

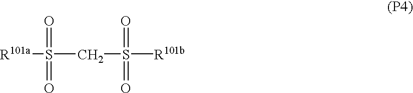

wherein, R^{101a} and R^{101b} are the same or different and have the same meanings as defined above.

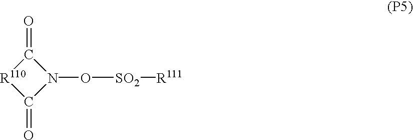

wherein, R¹¹⁰ represents a C₆₋₁₀ arylene group, a C₁₋₆ alkylene group, or a C₂₋₆ alkenylene group wherein hydrogen atoms may be partially or entirely replaced by a linear or branched C₁₋₄ alkyl or alkoxy group, a nitro group, an acetyl group, or a phenyl group, R¹¹¹ represents a linear, branched or cyclic C₁₋₈ alkyl, alkenyl or alkoxyalkyl group, a phenyl group, or a naphthyl group wherein hydrogen atoms may be partially or entirely replaced by a C₁₋₄ alkyl or alkoxy group, a phenyl group which may be substituted by a C₁₋₄ alkyl group, an alkoxy group, a nitro group, or an acetyl group, a C₃₋₅ hetero-aromatic group, or a chlorine or fluorine atom.

Examples of the arylene group represented by R¹¹⁰ include 1,2-phenylene and 1,8-naphthylene; those of the alkylene group include methylene, ethylene, trimethylene, tetramethylene, phenylethylene, and norbornane-2,3-diyl; and those of the alkenylene group include 1,2-vinylene, 1-phenyl-1,2-vinylene, and 5-norbornene-2,3-diyl.

Examples of the alkyl group as R¹¹¹ are similar to those described as R^{101a} to R^{101c}. Examples of the alkenyl group include vinyl, 1-propenyl, allyl, 1-butenyl, 3-butenyl, isoprenyl, 1-pentenyl, 3-pentenyl, 4-pentenyl, dimethylallyl, 1-hexenyl, 3-hexenyl, 5-hexenyl, 1-heptenyl, 3-heptenyl, 6-heptenyl, and 7-octenyl; and examples of the alkoxyalkyl group include methoxymethyl, ethoxymethyl, propoxymethyl, butoxymethyl, pentyloxymethyl, hexyloxymethyl, heptyloxymethyl, methoxyethyl, ethoxyethyl, propoxyethyl, butoxyethyl, pentyloxyethyl, hexyloxyethyl, methoxypropyl, ethoxypropyl, propoxypropyl, butoxypropyl, methoxybutyl, ethoxybutyl, propoxybutyl, methoxypentyl, ethoxypentyl, methoxyhexyl, and methoxyheptyl. Examples of the C₁₋₄ alkyl group which may be substituted further include methyl, ethyl, propyl, isopropyl, n-butyl, isobutyl and tert-butyl; examples of the C₁₋₄ alkoxy group include methoxy, ethoxy, propoxy, isopropoxy, n-butoxy, isobutoxy, and tert-butoxy; examples of the phenyl group which may be substituted by a C₁₋₄ alkyl group, an alkoxy group, a nitro group, or an acetyl group include phenyl, tolyl, p-tert-butoxyphenyl, p-acetylphenyl and p-nitrophenyl; and examples of the C₃₋₅ hetero-aromatic group include pyridyl and furyl. Specific examples of the acid generator include onium salts such as diphenyliodonium trifluoromethanesulfonate, (p-tert-butoxyphenyl)phenyliodonium trifluoromethanesulfonate, diphenyliodonium p-toluenesulfonate, (p-tert-butoxyphenyl)phenyliodonium p-toluenesulfonate, triphenylsulfonium trifluoromethanesulfonate, (p-tert-butoxyphenyl)diphenylsulfonium trifluoromethanesulfonate, bis(p-tert-butoxyphenyl)phenylsulfonium trifluoromethanesulfonate, tris(p-tert-butoxyphenyl)sulfonium trifluoromethanesulfonate, triphenylsulfonium p-toluenesulfonate, (p-tert-butoxyphenyl)diphenylsulfonium p-toluenesulfonate, bis(p-tert-butoxyphenyl)phenylsulfonium p-toluenesulfonate, tris(p-tert-butoxyphenyl)sulfonium p-toluenesulfonate, triphenylsulfonium nonafluorobutanesulfonate, triphenylsulfonium butanesulfonate, trimethylsulfonium trifluoromethanesulfonate, trimethylsulfonium p-toluenesulfonate, cyclohexylmethyl(2-oxocyclohexyl)sulfonium trifluoromethanesulfonate, cyclohexylmethyl(2-oxocyclohexyl)sulfonium p-toluenesulfonate, dimethylphenylsulfonium trifluoromethanesulfonate, dimethylphenylsulfonium p-toluenesulfonate, dicyclohexylphenylsulfonium trifluoromethanesulfonate, dicyclohexylphenylsulfonium p-toluenesulfonate, trinaphthylsulfonium trifluoromethanesulfonate, cyclohexylmethyl(2-oxocyclohexyl)sulfonium trifluoromethanesulfonate, (2-norbornyl)methyl(2-oxocyclohexyl)sulfonium trifluoromethanesulfonate, ethylenebis[methyl(2-oxocyclopentyl)sulfonium trifluoromethanesulfonate], and 1,2′-naphthylcarbonylmethyltetrahydrothiophenium triflate; diazomethane derivatives such as bis(benzenesulfonyl)diazomethane, bis(p-toluenesulfonyl)diazomethane, bis(xylenesulfonyl)diazomethane, bis(cyclohexylsulfonyl)diazomethane, bis(cyclopentylsulfonyl)diazomethane, bis(n-butylsulfonyl)diazomethane, bis(isobutylsulfonyl)diazomethane, bis(sec-butylsulfonyl)diazomethane, bis(n-propylsulfonyl)diazomethane, bis(isopropylsulfonyl)diazomethane, bis(tert-butylsulfonyl)diazomethane, bis(n-amylsulfonyl)diazomethane, bis(isoamylsulfonyl)diazomethane, bis(sec-amylsulfonyl)diazomethane, bis(tert-amylsulfonyl)diazomethane, 1-cyclohexylsulfonyl-1-(tert-butylsulfonyl)diazomethane, 1-cyclohexylsulfonyl-1-(tert-amylsulfonyl)diazomethane, and 1-tert-amylsulfonyl-1-(tert-butylsulfonyl)diazomethane; glyoxime derivatives such as bis-O-(p-toluenesulfonyl)-α-dimethylglyoxime, bis-O-(p-toluenesulfonyl)-α-diphenylglyoxime, bis-O-(p-toluenesulfonyl)-α-dicyclohexylglyoxime, bis-O-(p-toluenesulfonyl)-2,3-pentanedioneglyoxime, bis-o-(p-toluenesulfonyl)-2-methyl-3,4-pentanedioneglyoxime, bis-o-(n-butanesulfonyl)-α-dimethylglyoxime, bis-O-(n-butanesulfonyl)-α-diphenylglyoxime, bis-O-(n-butanesulfonyl)-α-dicyclohexylglyoxime, bis-O-(n-butanesulfonyl)-2,3-pentanedioneglyoxime, bis-O-(n-butanesulfonyl)-2-methyl-3,4-pentanedioneglyoxime, bis-O-(methanesulfonyl)-α-dimethylglyoxime, bis-O-(trifluoromethanesulfonyl)-α-dimethylglyoxime, bis-O-(1,1,1-trifluoroethanesulfonyl)-α-dimethylglyoxime, bis-O-(tert-butanesulfonyl)-α-dimethylglyoxime, bis-O-(perfluorooctanesulfonyl)-α-dimethylglyoxime, bis-O-(cyclohexanesulfonyl)-α-dimethylglyoxime, bis-O-(benzenesulfonyl)-α-dimethylglyoxime, bis-o-(p-fluorobenzenesulfonyl)-α-dimethylglyoxime, bis-O-(p-tert-butylbenzenesulfonyl)-α-dimethylglyoxime, bis-O-(xylenesulfonyl)-α-dimethylglyoxime, and bis-O-(camphorsulfonyl)-α-dimethylglyoxime; bissulfone derivatives such as bisnaphthylsulfonylmethane, bistrifluoromethylsulfonylmethane, bismethylsulfonylmethane, bisethylsulfonylmethane, bispropylsulfonylmethane, bisisopropylsulfonylmethane, bis-p-toluenesulfonylmethane, and bisbenzenesulfonylmethane; 3-ketosulfone derivatives s u c h as 2-cyclohexylcarbonyl-2-(p-toluenesulfonyl)propane and 2-isopropylcarbonyl-2-(p-toluenesulfonyl)propane; disulfone derivatives such as diphenyl disulfone and dicyclohexyl disulfone; nitrobenzyl sulfonate derivatives such as 2,6-dinitrobenzyl p-toluenesulfonate and 2,4-dinitrobenzyl p-toluenesulfonate; sulfonic acid ester derivatives such as 1,2,3-tris(methanesulfonyloxy)benzene, 1,2,3-tris(trifluoromethanesulfonyloxy)benzene, and 1,2,3-tris(p-toluenesulfonyloxy)benzene; and sulfonic acid esters of an N-hydroxyimide such as N-hydroxysuccinimide methanesulfonate, N-hydroxysuccinimide trifluoromethanesulfonate, N-hydroxysuccinimide ethanesulfonate, N-hydroxysuccinimide 1-propanesulfonate, N-hydroxysuccinimide 2-propanesulfonate, N-hydroxysuccinimide 1-pentanesulfonate, N-hydroxysuccinimide 1-octanesulfonate, N-hydroxysuccinimide p-toluenesulfonate, N-hydroxysuccinimide p-methoxybenzenesulfonate, N-hydroxysuccinimide 2-chloroethanesulfonate, N-hydroxysuccinimide benzenesulfonate, N-hydroxysuccinimide 2,4,6-trimethylbenzenesulfonate, N-hydroxysuccinimide 1-naphthalenesulfonate, N-hydroxysuccinimide 2-naphthalenesulfonate, N-hydroxy-2-phenylsuccinimide methanesulfonate, N-hydroxymaleimide methanesulfonate, N-hydroxymaleimide ethanesulfonate, N-hydroxy-2-phenylmaleimide methanesulfonate, N-hydroxyglutarimide methanesulfonate, N-hydroxyglutarimide benzenesulfonate, N-hydroxyphthalimide methanesulfonate, N-hydroxyphthalimide benzenesulfonate, N-hydroxyphthalimide trifluoromethanesulfonate, N-hydroxyphthalimide p-toluenesulfonate, N-hydroxynaphthalimide methanesulfonate, N-hydroxynaphthalimide benzenesulfonate, N-hydroxy-5-norbornene-2,3-dicarboxyimide methanesulfonate, N-hydroxy-5-norbornene-2,3-dicarboxyimide trifluoromethanesulfonate, and N-hydroxy-5-norbornene-2,3-dicarboxyimide p-toluenesulfonate. Of these, preferred are onium salts such as triphenylsulfonium trifluoromethanesulfonate, (p-tert-butoxyphenyl)diphenylsulfonium trifluoromethanesulfonate, tris(p-tert-butoxyphenyl)sulfonium trifluoromethanesulfonate, triphenylsulfonium p-toluenesulfonate, (p-tert-butoxyphenyl)diphenylsulfonium p-toluenesulfonate, tris(p-tert-butoxyphenyl)sulfonium p-toluenesulfonate, trinaphthylsulfonium trifluoromethanesulfonate, cyclohexylmethyl(2-oxocyclohexyl)sulfonium trifluoromethanesulfonate, (2-norbornyl)methyl(2-oxocylohexyl)sulfonium trifluoromethanesulfonate, and 1,2′-naphthylcarbonylmethyltetrahydrothiophenium triflate; diazomethane derivatives such as bis(benzenesulfonyl)diazomethane, bis(p-toluenesulfonyl)diazomethane, bis(cyclohexylsulfonyl)diazomethane, bis(n-butylsulfonyl)diazomethane, bis(isobutylsulfonyl)diazomethane, bis(sec-butylsulfonyl)diazomethane, bis(n-propylsulfonyl)diazomethane, bis(isopropylsulfonyl)diazomethane, and bis(tert-butylsulfonyl)diazomethane; glyoxime derivatives such as bis-O-(p-toluenesulfonyl)-α-dimethylglyoxime and bis-O-(n-butanesulfonyl)-α-dimethylglyoxime; bissulfone derivatives such as bisnaphthylsulfonylmethane; and sultonic acid esters of an N-hydroxyimide compound such as N-hydroxysuccinimide methanesulfonate, N-hydroxysuccinimide trifluoromethanesulfonate, N-hydroxysuccinimide 1-propanesulfonate, N-hydroxysuccinimide 2-propanesulfonate, N-hydroxysuccinimide 1-pentanesulfonate, N-hydroxysuccinimide p-toluenesulfonate, N-hydroxynaphthalimide methanesulfonate, and N-hydroxynaphthalimide benzenesulfonate.

These acid generators may be used singly or in combination. Onium salts have excellent effects for improving rectangularity, while diazomethane derivatives and glyoxime derivatives have excellent effects for reducing standing waves. Combined use of an onium salt with a diazomethane or a glyoxime derivative enables fine adjustment of the profile.

The acid generator is added in an amount of 0.1 to 15 parts by weight, preferably 0.5 to 8 parts by weight, per 100 parts by weight of the base resin. Amounts less than 0.1 part by weight may deteriorate a sensitivity, while those exceeding 15 parts by weight may lower transparency, thereby deteriorating resolution.

As the organic solvent, any organic solvent capable of dissolving therein the base resin, acid generator and another additive can be used in the invention. Examples of such an organic solvent include, but not limited thereto, ketones such as cyclohexanone and methyl-2-n-amylketone; alcohols such as 3-methoxybutanol, 3-methyl-3-methoxybutanol, 1-methoxy-2-propanol, and 1-ethoxy-2-propanol; ethers such as propylene glycol monomethyl ether, ethylene glycol monomethyl ether, propylene glycol monoethyl ether, ethylene glycol monoethyl ether, propylene glycol dimethyl ether, and diethylene glycol dimethyl ether; and esters such as propylene glycol monomethyl ether acetate, propylene glycol monoethyl ether acetate, ethyl lactate, ethyl pyruvate, butyl acetate, methyl 3-methoxypropionate, ethyl 3-ethoxypropionate, tert-butyl acetate, tert-butyl propionate, and propylene glycol mono-tert-butyl ether acetate. These solvents may be used either singly or in combination.

Of the above-described organic solvents, preferred are diethylene glycol dimethyl ether and 1-ethoxy-2-propanol which are excellent in dissolving therein the acid generator, and propylene glycol monomethyl ether acetate which is a safe solvent, and a mixture thereof.

The organic solvent is preferably added in an amount of 200 to 1,000 parts by weight, especially 400 to 800 parts by weight per 100 parts by weight of the base resin.

In the resist material of the invention, another polymer compound other than the polymer compound containing the epoxy compound of the present invention as recurring units can be incorporated. Specific examples of such polymer compound include, but not limited to, polymer compounds represented by the below-described formula (R1) and/or (R2) and having a weight average molecular weight of 1,000 to 500,000, preferably 5,000 to 100,000.

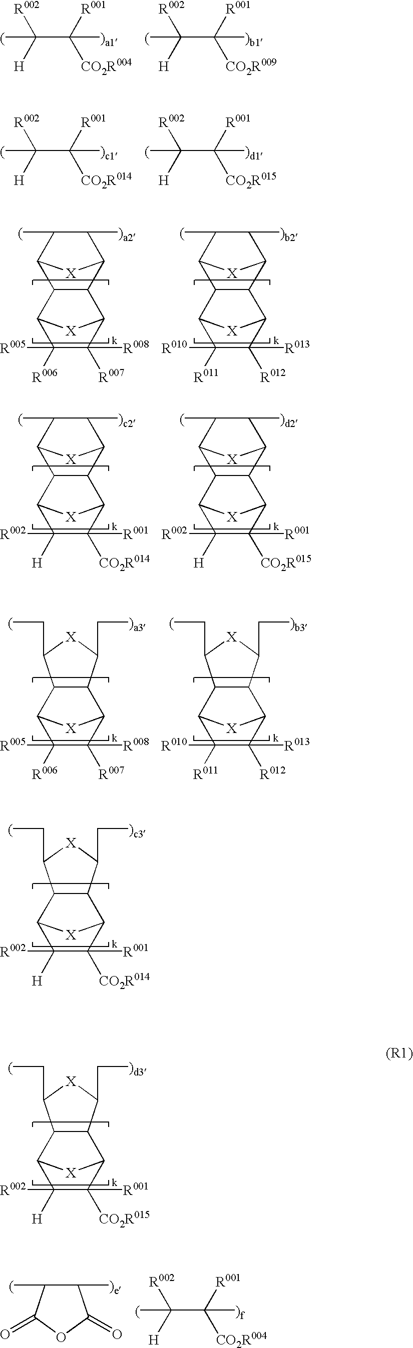

wherein, R⁰⁰¹s are the same or different and each represents a hydrogen atom, a methyl group, or CH₂CO₂R⁰⁰³, R⁰⁰² are the same or different and each represents a hydrogen atom, a methyl group, or a CO₂R⁰⁰³, R⁰⁰³s are the same or different and each represents a linear, branched or cyclic C₁₋₁₅ alkyl group, R⁰⁰⁴ s are the same or different and each represents a hydrogen atom or a monovalent C₁₋₁₅ hydrocarbon group having a carboxyl or hydroxyl group, at least one of R⁰⁰⁵ to R⁰⁰⁸ represents a monovalent C₁₋₁₅ hydrocarbon group having a carboxyl or hydroxyl group while the remaining ones each independently represents a hydrogen or a linear, branched or cyclic C₁₋₁₅ alkyl group, or R⁰⁰⁵ to R⁰⁰⁸ may be coupled together to form a ring, and in this case, at least one of R⁰⁰⁵ to R⁰⁰⁸ represents a divalent C₁₋₁₅ hydrocarbon group having a carboxyl or hydroxyl group, while the remaining ones each independently represents a single bond or a linear, branched or cyclic C₁₋₁₅ alkylene group, R⁰⁰⁹s are the same or different and each independently represents a monovalent C₂₋₁₅ hydrocarbon group containing at least one partial structure selected from ether, aldehyde, ketone, ester, carbonate, acid anhydride, amide and imide, at least one of R⁰¹⁰ to R⁰¹³ represents a monovalent C₂₋₁₅ hydrocarbon group containing at least one partial structure selected from ether, aldehyde, ketone, ester, carbonate, acid anhydride, amide and imide, while the remaining ones each independently represents a hydrogen atom or a linear, branched or cyclic C₁₋₁₅ alkyl group, R⁰¹⁰ to R⁰¹³ may be coupled together to form a ring, and in this case, at least one of R⁰¹⁰ to R⁰¹³ represents a divalent hydrocarbon group containing at least one partial structure selected from C₁₋₁₅ ether, aldehyde, ketone, ester, carbonate, acid anhydride, amide and imide, while the remaining ones each independently represents a single bond or a linear, branched or cyclic C₁₋₁₅ alkylene group, R⁰¹⁴ s are the same or different and each independently represents a polycyclic C₇₋₁₅ hydrocarbon group or an alkyl group containing a polycyclic hydrocarbon group, R⁰¹⁵ s are the same or different and each independently represents an acid-labile group, R⁰¹⁶ s are the same or different and each represents a hydrogen atom or a methyl group, R⁰¹⁷s are the same or different and each represents a linear, branched or cyclic C₁₋₈ alkyl group, Xs each independently represents CH₂ or an oxygen atom, letters k each independently stands for 0 or 1, a1′, a2′, a3′, b1′, b2′, b3′, c1′, c2′, c3′, d1′, d2′, d3′, and e′ are numbers from 0 to less than 1 and satisfies: a1′+a2′+a3′+b1′+b2′+b3′+c1′+c2′+c3′+d1′+d2′+d3′+e′=1, f′, g′, h′, i′, and j′ are each a number of from 0 to less than 1 and satisfy: f′+g′+h′+i′+j′=1, and x′, y′ and z′ each stands for an integer of 0 to 3 and satisfies: 1≦x′+y′+z′≦5, and 1≦y′+z′≦3.

It is preferred that the polymer compound of the invention and other polymer compound are blended at a weight ratio ranging from 100:0 to 10:90, especially from 100:0 to 20:80. When the blending ratio of the polymer compound of the invention is below the above-described range, the resulting resist material may fail to gain a desired performance, for example, high adhesion to a substrate and high resolution. The performance of the resist material can be controlled by changing the blending ratio as desired.

The polymer compound of the invention and another polymer compound are each not limited to one type. Plural polymer compounds may be used in combination. The use of plural polymer compounds facilitates control of the performance of the resist material.

To the resist material of the invention, a dissolution regulator may be added in order to make a sufficient difference in a dissolution rate between before and after exposure. As a dissolution regulator, incorporated in the resist material is a compound obtained by substituting, by an acid-labile group, 0 to 100 mol %, on average, of the hydrogen atoms on the phenolic hydroxyl group of a compound having an average molecular weight of 100 to 1,000, preferably 150 to 800 and having, in the molecule thereof, at least 2 phenolic hydroxyl groups; or a compound obtained by substituting, by an acid-labile group, 50 to 100 mol %, on average, of the hydrogen atoms on the carboxyl group of a compound having, in the molecule thereof, a carboxyl group.

The substitution rate of the hydrogen atoms on the phenolic hydroxyl group with an acid-labile group is on average at least 0 mol %, preferably at least 30 mol %, based on all the phenolic hydroxyl groups. The upper limit is 100 mol %, preferably 80 mol %. The substitution degree of the hydrogen atoms on the carboxyl groups with an acid-labile group is on average at least 50 mol %, preferably at least 70 mol %, based on all the carboxyl groups, with the upper limit being 100 mol %.

Preferred examples of such a compound having at least two phenolic hydroxyl groups or a compound having at least one carboxyl group include those represented by the following formulas (D1) to (D14):

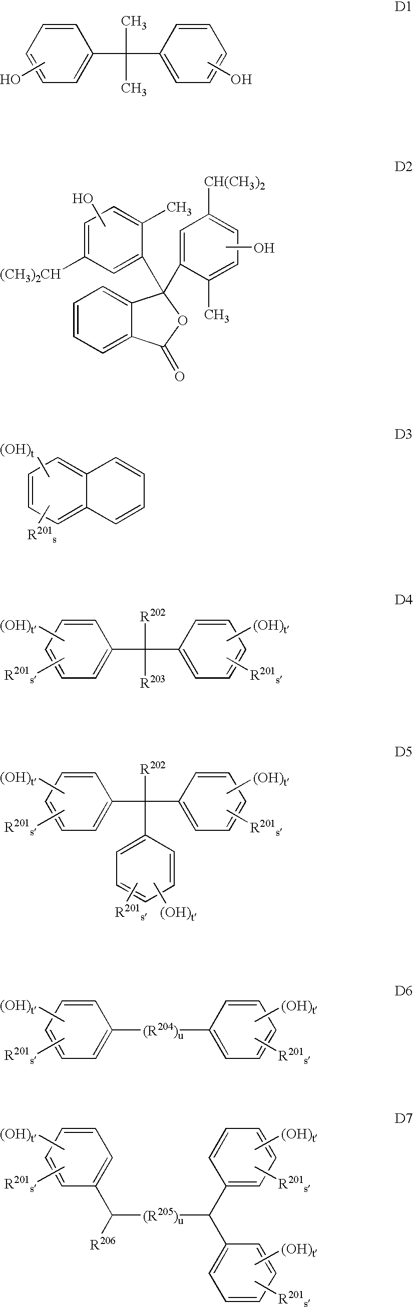

wherein, R²⁰¹ and R²⁰² are the same or different and each represents a hydrogen atom, or a linear or branched C₁₋₈ alkyl or alkenyl group, R²⁰³s each independently represents a hydrogen atom, a linear or branched C₁₋₈ alkyl or alkenyl group, or —(R 207)ₕ—COOH, R²⁰⁴ represents —(CH₂)ᵢ— (in which i=2 to 10), a C₆₋₁₀ arylene group, a carbonyl group, a sulfonyl group, an oxygen atom, or a sulfur atom, R²⁰⁵ represents a C₁₋₁₀ alkylene group, a C₆₋₁₀ arylene group, a carbonyl group, a sulfonyl group, an oxygen atom, or a sulfur atom, R²⁰⁶ represents a hydrogen atom, a linear or branched C₁₋₈ alkyl or alkenyl group, or a hydroxyl-substituted phenyl or naphthyl group, R²⁰⁷ represents a linear or branched C₁₋₁₀ alkylene group, R²⁰⁸s each independently represents a hydrogen atom or a hydroxyl group, the letter j stands for an integer of 0 to 5, u and h each independently stands for 0 or 1. Letters, s, t, s′, t′, s″, and t″ each stands for a number which satisfies s+t=8, s +t′=5, and s″+t″=4, and is determined so as to impart each phenyl skeleton with at least one hydroxyl group, and as each independently stands for such a number as to give 100 to 1,000 as the molecular weight of each of the compounds of formulas (D8) and (D9).

In the above-described formulas, R²⁰¹ and R²⁰² each represents a hydrogen atom, a methyl group, an ethyl group, a butyl group, a propyl group, an ethynyl group or a cyclohexyl group, R²⁰³ represents a group similar to that described as R²⁰¹ or R²⁰² or —COOH or —CH₂COOH, R²⁰⁴ represents an ethylene group, a phenylene group, a carbonyl group, a sulfonyl group, an oxygen atom or a sulfur atom, R²⁰⁵ represents a methylene group or a group similar to that described as R²⁰⁴, and R²⁰⁶ represents a hydrogen atom, a methyl group, an ethyl group, a butyl group, a propyl group, an ethynyl group, a cyclohexyl group or a phenyl or naphthyl group substituted by a hydroxyl group.

Various groups are usable as an acid-labile group with which the phenolic hydroxyl group of D1 to D14, which are used as a dissolution regulator, is substituted. Specific examples include groups represented by the below-described formulas (L1) to (L4), tertiary C₄₋₂₀ alkyl groups, trialkylsilyl groups having, as each of alkyl moieties, a C₁₋₆ alkyl group, and C₄₋₂₀ oxoalkyl groups.

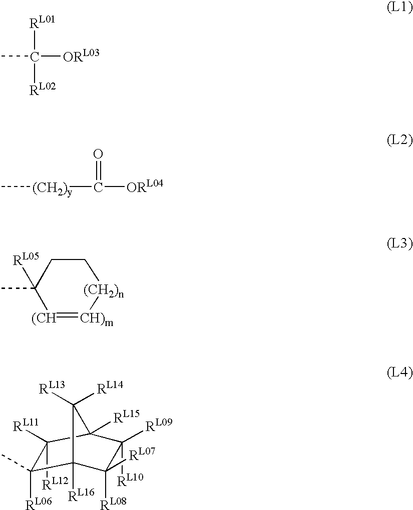

wherein, R^{L01} and R^{L02} are the same or different and each represents a hydrogen atom or a linear, branched or cyclic C₁₋₁₈ alkyl group, R^{L03} s are the same or different and each represents a monovalent C₁₋₁₈ hydrocarbon group which may have a hetero atom such as an oxygen atom, a pair R^{L01} and R^{L02}, R^{L01} and R^{L03}, or R^{L02} and R^{L03} may be coupled together to form a ring, with the proviso that when they form a ring, R^{L01}, R^{L02} and R^{L03} each represents a linear or branched C₁₋₈ alkylene group, R^{L04} represents a tertiary C₄₋₂₀ alkyl group, a trialkylsilyl group having, as each alkyl moiety, a C₁₋₆ alkyl group, a C₄₋₂₀ oxoalkyl group, or a group of formula (L1), R^{L05} represents a monovalent C₁₋₈ hydrocarbon group which may contain a hetero atom, or a substituted or unsubstituted C₆₋₂₀ aryl group, R^{L06} represents a monovalent c₁₋₈ hydrocarbon group which may have a hetero atom, or a substituted or unsubstituted C₆₋₂₀ aryl group, R^{L07} to R^{L16} each independently represents a hydrogen atom or a monovalent C₁₋₁₅ hydrocarbon group which may contain a hetero atom, R^{L07} to R^{L16} may be coupled together to form a ring with the proviso that when any two form a ring, R^{L07} to R^{L16} each represents a divalent C₁₋₁₅ hydrocarbon group which may contain a hetero atom, or R^{L07} to R^{L16} which are coupled to adjacent carbon atoms may bond together directly to form a double bond, y stands for an integer of 0 to 6, q stands 0 or 1, r stands for any one of 0, 1, 2 and 3, and q and r satisfy 2q+r=2 or 3.

The dissolution regulators can be synthesized by introducing an acid-labile group into a compound having a phenolic hydroxyl or carboxyl group in accordance with an organic chemical formulation.

The dissolution regulators are each added in an amount of 0 to 50 parts by weight, preferably 0 to 40 parts by weight, more preferably 0 to 30 parts by weight based on 100 parts by weight of the base resin. They may be used singly or as a mixture of two or more of them. Amounts exceeding 50 parts by weight may cause a decrease in the film thickness of patterns, leading to lowering in resolution.

In the resist material of the invention, one or more basic compounds may be incorporated. As the basic compound, suited is a compound capable of suppressing the diffusion rate of an acid which is generated from the acid generator and diffused in the resist film. By incorporating the basic compound, the diffusion rate of the acid in the resist film is suppressed, resulting in an improvement in the resolution, suppression of a change in the sensitivity after exposure, lowering in dependence on a substrate or environment, and improvement of the exposure latitude and the pattern profile.

Examples of basic compound include primary, secondary, and tertiary aliphatic amines, mixed amines, aromatic amines, heterocyclic amines, carboxyl-containing nitrogenous compounds, sulfonyl-containing nitrogenous compounds, hydroxyl-containing nitrogenous compounds, hydroxyphenyl-containing nitrogenous compounds, alcoholic nitrogenous compounds, amide derivatives, and imide derivatives.

More specifically, the primary aliphatic amines include ammonia, methylamine, ethylamine, n-propylamine, isopropylamine, n-butylamine, iso-butylamine, sec-butylamine, tert-butylamine, pentylamine, tert-amylamine, cyclopentylamine, hexylamine, cyclohexylamine, heptylamine, octylamine, nonylamine, decylamine, dodecylamine, cetylamine, methylenediamine, ethylenediamine, and tetraethylenepentamine. The secondary aliphatic amines include dimethylamine, diethylamine, di-n-propylamine, diisopropylamine, di-n-butylamine, diisobutylamine, di-sec-butylamine, dipentylamine, dicyclopentylamine, dihexylamine, dicyclohexylamine, diheptylamine, dioctylamine, dinonylamine, didecylamine, didodecylamine, dicetylamine, N,N-dimethylmethylenediamine, N,N-dimethylethylenediamine, and N,N-dimethyltetraethylenepentamine. The tertiary aliphatic amines include trimethylamine, triethylamine, tri-n-propylamine, triisopropylamine, tri-n-butylamine, triisobutylamine, tri-sec-butylamine, tripentylamine, tricyclopentylamine, trihexylamine, tricyclohexylamine, triheptylamine, trioctylamine, trinonylamine, tridecylamine, tridodecylamine, tricetylamine, N,N,N′,N′-tetramethylmethylenediamine, N,N,N′,N′-tetramethylethylenediamine, and N,N,N′,N′-tetramethyltetraethylenepentamine.

Examples of the mixed amines include dimethylethylamine, methylethylpropylamine, benzylamine, phenethylamine, and benzyldimethylamine. Specific examples of the aromatic and heterocyclic amines include aniline derivatives (e.g., aniline, N-methylaniline, N-ethylaniline, N-propylaniline, N,N-dimethylaniline, 2-methylaniline, 3-methylaniline, 4-methylaniline, ethylaniline, propylaniline, trimethylaniline, 2-nitroaniline, 3-nitroaniline, 4-nitroaniline, 2,4-dinitroaniline, 2,6-dinitroaniline, 3,5-dinitroaniline, and N,N-dimethyltoluidine), diphenyl(p-tolyl)amine, methyldiphenylamine, triphenylamine, phenylenediamine, naphthylamine, diaminonaphthalene, pyrrole derivatives (e.g., pyrrole, 2H-pyrrole, 1-methylpyrrole, 2,4-dimethylpyrrole, 2,5-dimethylpyrrole, and N-methylpyrrole), oxazole derivatives (e.g., oxazole and isooxazole), thiazole derivatives (e.g., thiazole and isothiazole), imidazole derivatives (e.g., imidazole, 4-methylimidazole, and 4-methyl-2-phenylimidazole), pyrazole derivatives, furazan derivatives, pyrroline derivatives (e.g., pyrroline and 2-methyl-1-pyrroline), pyrrolidine derivatives (e.g., pyrrolidine, N-methylpyrrolidine, pyrrolidinone, and N-methylpyrrolidone), imidazoline derivatives, imidazolidine derivatives, pyridine derivatives (e.g., pyridine, methylpyridine, ethylpyridine, propylpyridine, butylpyridine, 4-(1-butylpentyl)pyridine, dimethylpyridine, trimethylpyridine, triethylpyridine, phenylpyridine, 3-methyl-2-phenylpyridine, 4-tert-butylpyridine, diphenylpyridine, benzylpyridine, methoxypyridine, butoxypyridine, dimethoxypyridine, 1-methyl-2-pyridone, 4-pyrrolidinopyridine, 1-methyl-4-phenylpyridine, 2-(1-ethylpropyl)pyridine, aminopyridine, and dimethylaminopyridine), pyridazine derivatives, pyrimidine derivatives, pyrazine derivatives, pyrazoline derivatives, pyrazolidine derivatives, piperidine derivatives, piperazine derivatives, morpholine derivatives, indole derivatives, isoindole derivatives, 1H-indazole derivatives, indoline derivatives, quinoline derivatives (e.g., quinoline and 3-quinolinecarbonitrile), isoquinoline derivatives, cinnoline derivatives, quinazoline derivatives, quinoxaline derivatives, phthalazine derivatives, purine derivatives, pteridine derivatives, carbazole derivatives, phenanthridine derivatives, acridine derivatives, phenazine derivatives, 1,10-phenanthroline derivatives, adenine derivatives, adenosine derivatives, guanine derivatives, guanosine derivatives, uracil derivatives, and uridine derivatives.

The carboxyl-containing nitrogenous compounds include aminobenzoic acid, indolecarboxylic acid, and amino acid derivatives (e.g. nicotinic acid, alanine, alginine, aspartic acid, glutamic acid, glycine, histidine, isoleucine, glycylleucine, leucine, methionine, phenylalanine, threonine, lysine, 3-aminopyrazine-2-carboxylic acid, and methoxyalanine); the sulfonyl-containing nitrogenous compounds include 3-pyridinesulfonic acid and pyridinium p-toluenesulfonate; examples of the hydroxyl-containing nitrogenous compounds, hydroxyphenyl-containing nitrogenous compounds, and alcoholic nitrogenous compounds include 2-hydroxypyridine, aminocresol, 2,4-quinolinediol, 3-indolemethanol hydrate, monoethanolamine, diethanolamine, triethanolamine, N-ethyldiethanolamine, N,N-diethylethanolamine, triisopropanolamine, 2,2′-iminodiethanol, 2-aminoethanol, 3-amino-1-propanol, 4-amino-1-butanol, 4-(2-hydroxyethyl)morpholine, 2-(2-hydroxyethyl)pyridine, 1-(2-hydroxyethyl)piperazine, 1-[2-(2-hydroxyethoxy)ethyl]piperazine, piperidine ethanol, 1-(2-hydroxyethyl)pyrrolidine, 1-(2-hydroxyethyl)-2-pyrrolidinone, 3-piperidino-1,2-propanediol, 3-pyrrolidino-1,2-propanediol, 8-hydroxyjulolidine, 3-quinuclidinol, 3-tropanol, 1-methyl-2-pyrrolidine ethanol, 1-aziridine ethanol, N-(2-hydroxyethyl)phthalimide, and N-(2-hydroxyethyl)isonicotinamide. The amide derivatives include formamide, N-methylformamide, N,N-dimethylformamide, acetamide, N-methylacetamide, N,N-dimethylacetamide, propionamide, and benzamide. The imide derivatives include phthalimide, succinimide, and maleimide.

It is also possible to incorporate one or more basic compounds selected from those represented by the below-described formula (B1):

N(X¹)ₙ₁(Y¹)₃₋ₙ₁ B1

wherein, n1 is equal to 1, 2 or 3, Y¹ each independently represents a hydrogen atom or a linear, branched or cyclic C₁₋₂₀ alkyl group which may contain a hydroxyl group or an ether structure, and X¹s each independently represents any one of the groups represented by the below-described formulas (X1) to (X3), with the proviso that two or three X¹s may be coupled together to form a ring.

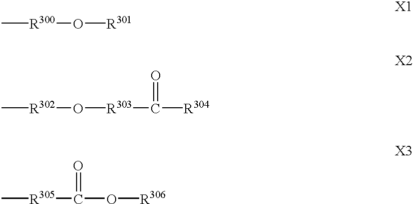

wherein, R³⁰⁰, R³⁰² and R³⁰⁵ are the same or different and each represents a linear or branched C₁₋₄ alkylene group; R³⁰¹, R³⁰⁴ and R³⁰⁶ are the same or different and each represents a hydrogen atom, a linear, branched or cyclic C₁₋₂₀ alkyl group, which may contain at least one hydroxyl group, ether structure, ester structure or lactone ring, and R³⁰³ represents a single bond or a linear or branched C₁₋₄ alkylene group.

Specific examples of the basic compound of the formula (B1) include tris(2-methoxymethoxyethyl)amine, tris{2-(methoxyethoxy)ethyl}amine, tris{2-(2-methoxyethoxymethoxy)ethyl}amine, tris{2-(1-methoxyethoxy)ethyl}amine, tris{2-(1-ethoxyethoxy)ethyl}amine, tris{2-(1-ethoxypropoxy)ethyl}amine, tris[2-{2-(2-hydroxyethoxy)ethoxy}ethyl]amine, 4,7,13,16,21,24-hexaoxa -1,10-diazabicyclo[8.8.8]hexacosane, 4,7,13,18-tetraoxa-1,10-diazabicyclo[8.5.5]eicosane, 1,4,10,13-tetraoxa-7,16-diazabicyclooctadecane, 1-aza-12-crown-4,1-aza-15-crown-5, 1-aza-18-crown-6, tris(2-formyloxyethyl)amine, tris(2-acetoxyethyl)amine, tris(2-propionyloxyethyl)amine, tris(2-butyryloxyethyl)amine, tris(2-isobutyryloxyethyl)amine, tris(2-valeryloxyethyl)amine, tris(2-pivaloyloxyethyl)amine, N,N-bis(2-acetoxyethyl)-2-(acetoxyacetoxy)ethylamine, tris(2-methoxycarbonyloxyethyl)amine, tris(2-tert-butoxycarbonyloxyethyl)amine, tris[2-(2-oxopropoxy)ethyl]amine, tris[2-(methoxycarbonylmethyl)oxyethyl]amine, tris[2-(tert-butoxycarbonylmethyloxy)ethyl]amine, tris[2-(cyclohexyloxycarbonylmethyloxy)ethyl]amine, tris(2-methoxycarbonylethyl)amine, tris(2-ethoxycarbonylethyl)amine, N,N-bis(2-hydroxyethyl) 2-(methoxycarbonyl)ethylamine, N,N-bis(2-acetoxyethyl) 2-(methoxycarbonyl)ethylamine, N,N-bis(2-hydroxyethyl) 2-(ethoxycarbonyl)ethylamine, N,N-bis(2-acetoxyethyl) 2-(ethoxycarbonyl)ethylamine, N,N-bis(2-hydroxyethyl) 2-(2-methoxyethoxycarbonyl)ethylamine, N,N-bis(2-acetoxyethyl) 2-(2-methoxyethoxycarbonyl)ethylamine, N,N-bis(2-hydroxyethyl) 2-(2-hydroxyethoxycarbonyl)ethylamine, N,N-bis(2-acetoxyethyl) 2-(2-acetoxyethoxycarbonyl)ethylamine, N,N-bis(2-hydroxyethyl) 2-[(methoxycarbonyl)methoxycarbonyl]ethylamine, N,N-bis(2-acetoxyethyl) 2-[(methoxycarbonyl)methoxycarbonyl]ethylamine, N,N-bis(2-hydroxyethyl) 2-(2-oxopropoxycarbonyl)ethylamine, N,N-bis(2-acetoxyethyl) 2-(2-oxopropoxycarbonyl)ethylamine, N,N-bis(2-hydroxyethyl) 2-(tetrahydrofurfuryloxycarbonyl)ethylamine, N,N-bis(2-acetoxyethyl) 2-(tetrahydrofurfuryloxycarbonyl)ethylamine, N,N-bis(2-hydroxyethyl) 2-[(2-oxotetrahydrofuran-3-yl)oxycarbonyl]ethylamine, N,N-bis(2-acetoxyethyl) 2-[(2-oxotetrahydrofuran-3-yl)oxycarbonyl]ethylamine, N,N-bis(2-hydroxyethyl) 2-(4-hydroxybutoxycarbonyl)ethylamine, N,N-bis(2-formyloxyethyl) 2-(4-formyloxybutoxycarbonyl)ethylamine, N,N-bis(2-formyloxyethyl) 2-(2-formyloxyethoxycarbonyl)ethylamine, N,N-bis(2-methoxyethyl) 2-(methoxycarbonyl)ethylamine, N-(2-hydroxyethyl) bis[2-(methoxycarbonyl)ethyl]amine, N-(2-acetoxyethyl) bis[2-(methoxycarbonyl)ethyl]amine, N-(2-hydroxyethyl) bis[2-(ethoxycarbonyl)ethyl]amine, N-(2-acetoxyethyl) bis[2-(ethoxycarbonyl)ethyl]amine, N-(3-hydroxy-1-propyl) bis[2-(methoxycarbonyl)ethyl]amine, N-(3-acetoxy-1-propyl) bis[2-(methoxycarbonyl)ethyl]amine, N-(2-methoxyethyl) bis[2-(methoxycarbonyl)ethyl]amine, N-butyl-bis[2-(methoxycarbonyl)ethyl]amine, N-butyl-bis[2-(2-methoxyethoxycarbonyl)ethyl]amine, N-methyl-bis(2-acetoxyethyl)amine, N-ethyl-bis(2-acetoxyethyl)amine, N-methyl-bis(2-pivaloyloxyethyl)amine, N-ethyl-bis[2-(methoxycarbonyloxy)ethyl]amine, N-ethyl-bis[2-(tert-butoxycarbonyloxy)ethyl]amine, tris(methoxycarbonylmethyl)amine, tris(ethoxycarbonylmethyl)amine, N-butyl-bis(methoxycarbonylmethyl)amine, N-hexylbis (methoxycarbonylmethyl) amine, and β-(diethylamino)-δ-valerolactone.

It is also possible to incorporate one or more basic compounds selected from cyclic-structure-containing basic compounds represented by the following formula (B2):

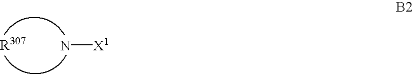

wherein, X¹ has the same meaning as defined above, and R³⁰⁷ represents a linear or branched C₂₋₂₀ alkylene group which may contain one or more carbonyl groups, ether structures, ester structures or sulfide structures.

Specific examples of the cyclic-structure-containing basic compounds represented by the formula (B2) include 1-[2-(methoxymethoxy)ethyl]pyrrolidine, 1-[2-(methoxymethoxy)ethyl]piperidine, 4-[2-(methoxymethoxy)ethyl]morpholine, 1-[2-[(2-methoxyethoxy)methoxy]ethyl]pyrrolidine, 1-[2-[(2-methoxyethoxy)methoxy]ethyl]piperidine, 4-[2-[(2-methoxyethoxy)methoxy]ethyl]morpholine, 2-(1-pyrrolidinyl)ethyl acetate, 2-piperidinoethyl acetate, 2-morpholinoethyl acetate, 2-(1-pyrrolidinyl)ethyl formate, 2-piperidinoethyl propionate, 2-morpholinoethyl acetoxyacetate, 2-(1-pyrrolidinyl)ethyl methoxyacetate, 4-[2-(methoxycarbonyloxy)ethyl]morpholine, 1-[2-(t-butoxycarbonyloxy)ethyl]piperidine, 4-[2-(2-methoxyethoxycarbonyloxy)ethyl]morpholine, methyl 3-(1-pyrrolidinyl)propionate, methyl 3-piperidinopropionate, methyl 3-morpholinopropionate, methyl 3-(thiomorpholino)propionate, methyl 2-methyl-3-(1-pyrrolidinyl)propionate, ethyl 3-morpholinopropionate, methoxycarbonylmethyl 3-piperidinopropionate, 2-hydroxyethyl 3-(1-pyrrolidinyl)propionate, 2-acetoxyethyl 3-morpholinopropionate, 2-oxotetrahydrofuran-3-yl 3-(1-pyrrolidinyl)propionate, tetrahydrofurfuryl 3-morpholinopropionate, glycidyl 3-piperidinopropionate, 2-methoxyethyl 3-morpholinopropionate, 2-(2-methoxyethoxy)ethyl 3-(1-pyrrolidinyl)propionate, butyl 3-morpholinopropionate, cyclohexyl 3-piperidinopropionate, α-(1-pyrrolidinyl)methyl-γ-butyrolactone, β-piperidino-α-butyrolactone, β-morpholino-δ-valerolactone, methyl 1-pyrrolidinylacetate, methyl piperidinoacetate, methyl morpholinoacetate, methyl thiomorpholinoacetate, ethyl 1-pyrrolidinylacetate, and 2-methoxyethyl morpholinoacetate.

It is also possible to incorporate one or more basic compounds selected from cyano-containing basic compounds represented by the below-described formulae (B3) to (B6).

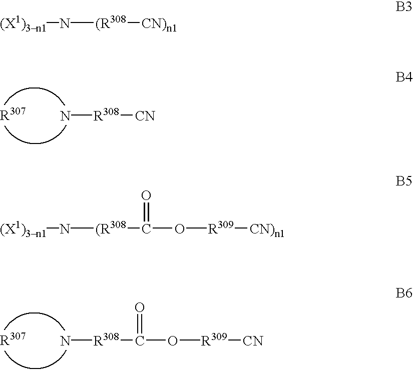

wherein, X¹, R³⁰⁷ and n1 have the same meanings as defined above, and R³⁰⁸ and R³⁰⁹ each independently represents a linear or branched C₁₋₄ alkylene group.

Specific examples of the cyano-containing basic compounds represented by the formulas (B3) to (B6) include 3-(diethylamino)propiononitrile, N,N-bis(2-hydroxyethyl)-3-aminopropiononitrile, N,N-bis(2-acetoxyethyl)-3-aminopropiononitrile, N,N-bis(2-formyloxyethyl)-3-aminopropiononitrile, N,N-bis(2-methoxyethyl)-3-aminopropiononitrile, N,N-bis(2-(methoxymethoxy)ethyl]-3-aminopropiononitrile, methyl N-(2-cyanoethyl)-N-(2-methoxyethyl)-3-aminopropionate, methyl N-(2-cyanoethyl) -N-(2-hydroxyethyl)-3-aminopropionate, methyl N-(2-acetoxyethyl)-N-(2-cyanoethyl)-3-aminopropionate, N-(2-cyanoethyl)-N-ethyl-3-aminopropiononitrile, N-(2-cyanoethyl) -N-(2-hydroxyethyl)-3-aminopropiononitrile, N-(2-acetoxyethyl)-N-(2-cyanoethyl)-3-aminopropiononitrile, N-(2-cyanoethyl)-N-(2-formyloxyethyl)-3-aminopropiononitrile, N-(2-cyanoethyl)-N-(2-methoxyethyl)-3-aminopropiononitrile, N-(2-cyanoethyl)-N-[2-(methoxymethoxy)ethyl]-3-aminopropiononitrile, N-(2-cyanoethyl)-N-(3-hydroxy-1-propyl)-3-aminopropiononitrile, N-(3-acetoxy-1-propyl)-N-(2-cyanoethyl)-3-aminopropiononitrile, N-(2-cyanoethyl)-N-(3-formyloxy-1-propyl)-3-aminopropiononitrile, N-(2-cyanoethyl)-N-tetrahydrofurfuryl -3-aminopropiononitrile, N,N-bis(2-cyanoethyl)-3-aminopropiononitrile, diethylaminoacetonitrile, N,N-bis(2-hydroxyethyl)aminoacetonitrile, N,N-bis(2-acetoxyethyl)aminoacetonitrile, N,N-bis(2-formyloxyethyl)aminoacetonitrile, N,N-bis(2-methoxyethyl)aminoacetonitrile, N,N-bis[2-(methoxymethoxy)ethyl]aminoacetonitrile, methyl N-cyanomethyl -N-(2-methoxyethyl)-3-aminopripionate, methyl N-cyanomethyl -N-(2-hydroxyethyl)-3-aminopropionate, methyl N-(2-acetoxyethyl)-N-cyanomethyl-3-aminopropionate, N-cyanomethyl -N-(2-hydroxyethyl)aminoacetonitrile, N-(2-acetoxyethyl)-N-(cyanomethyl)aminoacetonitrile, N-cyanomethyl -N-(2-formyloxyethyl)aminoacetonitrile, N-cyanomethyl -N-(2-methoxyethyl)aminoacetonitrile, N-cyanomethyl-N-[2-(methoxymethoxy)ethyl)aminoacetonitrile, N-cyanomethyl -N-(3-hydroxy-1-propyl)aminoacetonitrile, N-(3-acetoxy-1-propyl)-N-(cyanomethyl)aminoacetonitrile, N-cyanomethyl-N -(3-formyloxy-1-propyl)aminoacetonitrile, N,N-bis(cyanomethyl)aminoacetonitrile, 1-pyrrolidinepropiononitrile, 1-piperidinepropiononitrile, 4-morpholinepropiononitrile, 1-pyrrolidineacetonitrile, 1-piperidineacetonitrile, 4-morpholineacetonitrile, cyanomethyl 3-diethylaminopropionate, cyanomethyl N,N-bis(2-hydroxyethyl)-3-aminopropionate, cyanomethyl N,N-bis(2-acetoxyethyl)-3-aminopropionate, cyanomethyl N,N-bis(2-formyloxyethyl)-3-aminopropionate, cyanomethyl N,N-bis(2-methoxyethyl)-3-aminopropionate, cyanomethyl N,N-bis[2-(methoxymethoxy)ethyl]-3-aminopropionate, (2-cyanoethyl) 3-diethylaminopropionate, (2-cyanoethy) N,N-bis(2-hydroxyethyl)-3-aminopropionate, (2-cyanoethyl) N,N-bis(2-acetoxyethyl)-3-aminopropionate, (2-cyanoethyl) N,N-bis(2-formyloxyethyl)-3-aminopropionate, (2-cyanoethyl) N,N-bis(2-methoxyethyl)-3-aminopropionate, (2-cyanoethyl) N,N-bis[2-(methoxymethoxy)ethyl]-3-aminopropionate, cyanomethyl 1-pyrrolidinepropionate, cyanomethyl 1-piperidinepropionate, cyanomethyl 4-morpholinepropionate, (2-cyanoethyl) 1-pyrrolidinepropionate, (2-cyanoethyl) 1-piperidinepropionate, and (2-cyanoethyl) 4-morpholinepropionate.

The basic compound is added in an amount of 0.001 to 10 parts by weight, preferably 0.01 to 1 part by weight based on 1 part by weight of the acid generator. When the amount is less than 0.001 part by weight, the basic compound sometimes cannot exhibit its effect sufficiently, while amounts exceeding 10 parts by weight may deteriorate resolution or sensitivity.

In the resist material of the invention, a compound having, in the molecule thereof, a group of the formula —C—COOH may be incorporated. Addition of this component improves PED stability of the resist, thereby lessening edge roughness on the nitride film substrate.

Examples of the compound having, in the molecule thereof, the ≡C—COOH group include, but not limited to, one or more compounds selected from the below-described Groups I and II.

[Group I]

Compounds obtained by substituting hydrogen atoms on one or more phenolic hydroxyl groups of the compounds represented by the below-described formulas (A-1) to (A-10) with —R⁴⁰¹—COOH (wherein R⁴⁰¹S each independently represents a linear or branched C₁₋₁₀ alkylene group), and in which the molar ratio C/(C+D) wherein C is the phenolic hydroxyl group and D is the ≡C—COOH group, in the molecule is from 0.1 to 1.0.

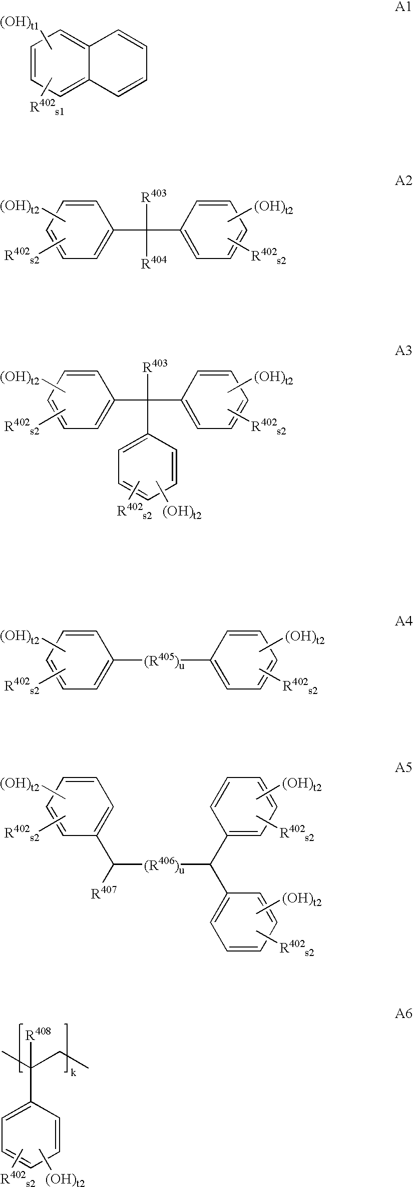

wherein, R⁴⁰⁸ represents a hydrogen atom or a methyl group; R⁴⁰² and R⁴⁰³ each represents a hydrogen atom or a linear or branched C₁₋₈ alkyl or alkenyl group; R⁴⁰⁴ represents a hydrogen atom, a linear or branched C₁₋₈ alkyl or alkenyl group, or a group —(R⁴⁰⁹)ₕ—COOR′ (R′ representing a hydrogen atom or —R⁴⁰⁹—COOH); R⁴⁰⁵ represents —(CH₂)ᵢ— (wherein i=2 to 10), a C₆₋₁₀ arylene group, a carbonyl group, a sulfonyl group, an oxygen atom, or a sulfur atom; R⁴⁰⁶ represents a C₁₋₁₀ alkylene group, a C₆₋₁₀ arylene group, a carbonyl group, a sulfonyl group, an oxygen atom, or a sulfur atom; R⁴⁰⁷ represents a hydrogen atom, a linear or branched C₁₋₈ alkyl or alkenyl group, or a hydroxyl-substituted phenyl or naphthyl group; R⁴⁰⁹ represents a linear or branched C₁₋₁₀ alkylene group; R⁴¹⁰ represents a hydrogen atom, a linear or branched C₁₋₈ alkyl or alkenyl group, or a group —R⁴¹¹—COOH; R⁴¹¹ represents a linear or branched C₁₋₁₀ alkylene group; j stands for an integer of 0 to 5; u and h each stands for 0 or 1; s1, t1, s2, t2, s3, t3, s4, and t4 are each numbers which satisfy s1+t1=8, s2+t2=5, s3+t3=4, and s4+t4=6, and permit each phenyl skeleton to have at least one hydroxyl group; κ is a number permitting the compound of formula (A6) to have a weight average molecular weight of 1,000 to 5,000; and λ is a number permitting the compound of formula (A7) to have a weight average molecular weight of 1,000 to 10,000.

[Group II]

Compounds represented by the following formulas (A11) to (A15):

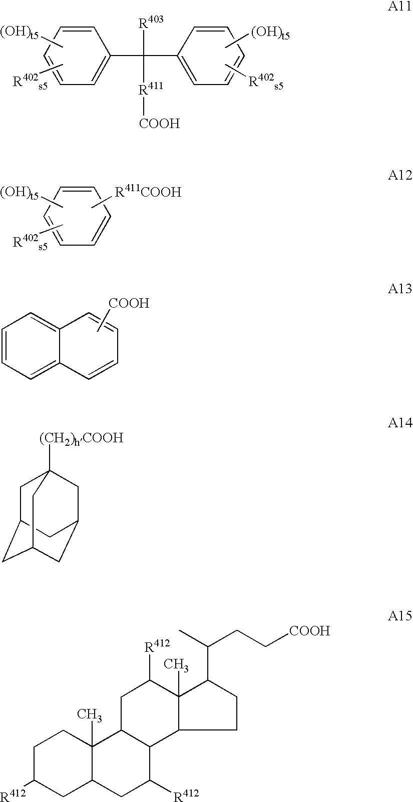

wherein, R⁴⁰², R⁴⁰³, and R⁴¹¹ have the same meanings as described above; R⁴¹² represents a hydrogen atom or a hydroxyl group; s5 and t5 are numbers which satisfy s5≧0, t5≧0, and s5+t5=5; and h′ stands for 0 or 1.

Specific examples of this component having the group ≡C—COOH include, but not limited to, compounds represented by the following formulas AI-1 to AI-14 and AII-1 to AII-10.

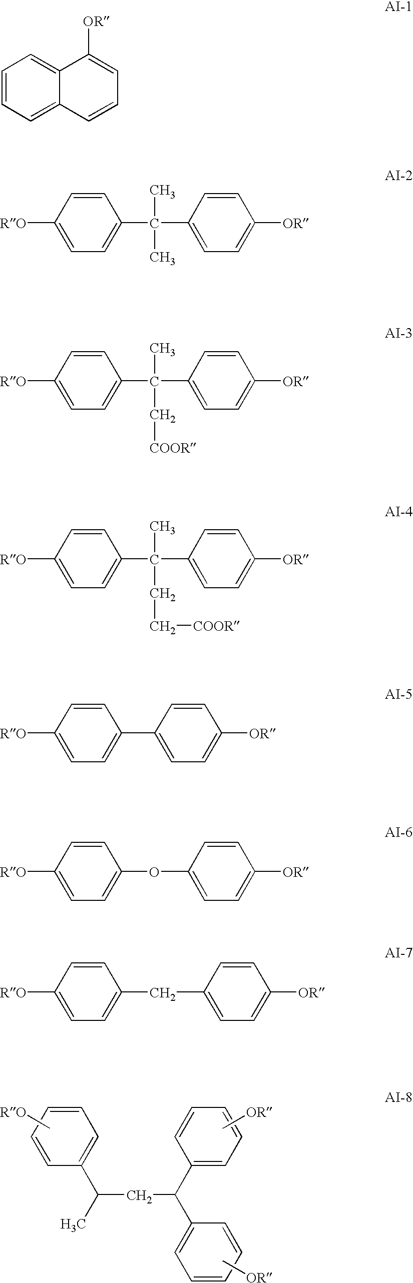

wherein, R″ represents a hydrogen atom or a CH₂COOH group with the proviso that in each compound, 10 to 100 mol % of R″ is a CH₂COOH group, α and κ have the same meanings as described above.

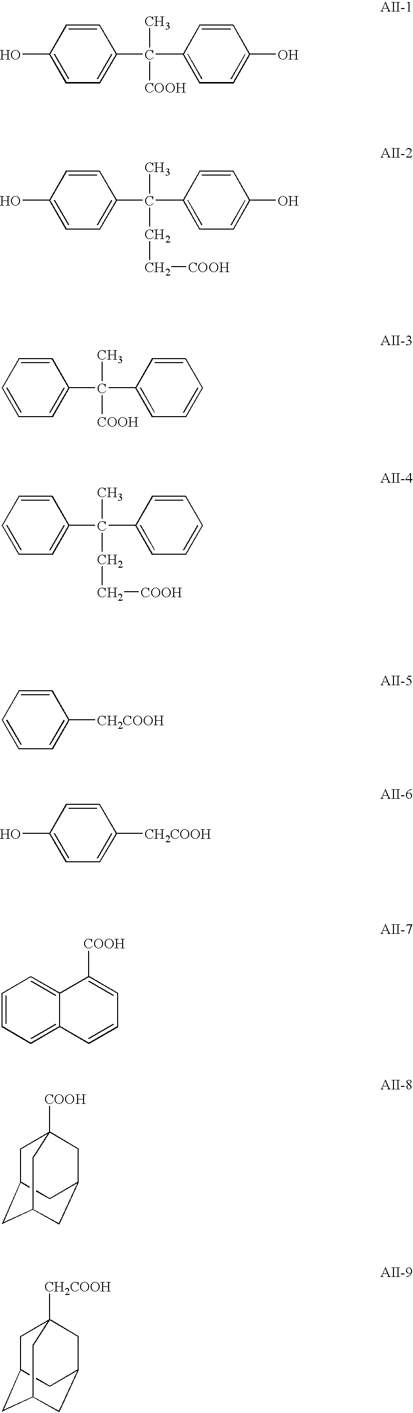

The compounds having, in the molecule thereof, the ≡C—COOH group may be used singly or in combination.

The compound having, in the molecule thereof, the ≡C—COOH group is added in an amount of 0 to 5 parts by weight, preferably 0.1 to 5 parts by weight, more preferably 0.1 to 3 parts by weight, still more preferably 0.1 to 2 parts by weight based on 100 parts by weight of the base resin. Amounts exceeding 5 parts by weight of the compound may deteriorate the resolution of the resulting resist material.

The resist material of the invention may further contain one or more acetylene alcohol derivatives for improving storage stability.

As the acetylene alcohol derivatives, those represented by the below-described formulas (S1) and (S2) are preferred.

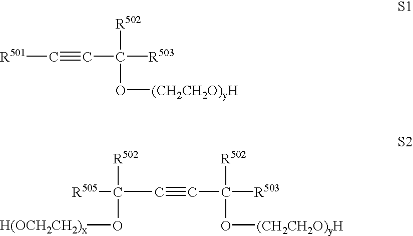

wherein, R⁵⁰¹, R⁵⁰², R⁵⁰³, R⁵⁰⁴, and R⁵⁰⁵ are the same or different and each represents a hydrogen atom or a linear, branched or cyclic C₁₋₈ alkyl group; and V and W each independently stands for 0 or a positive number and satisfies 0≦V≦30, 0≦W≦30, and 0≦V+W≦40.

Preferred examples of the acetylene alcohol derivative include Surfynol 61, Surfynol 82, Surfynol 104, Surfynol 104E, Surfynol 104H, Surfynol 104A, Surfynol TG, Surfynol PC, Surfynol 440, Surfynol 465, and Surfynol 485 (each trade name, product of Air Products and Chemicals Inc.) and Surfynol E1004 (trade name; product of Nisshin Chemical Industry Co., Ltd.).

The acetylene alcohol derivative is added in an amount of 0.01 to 2 wt. %, preferably 0.02 to 1 wt. %, based on 100 wt. % by weight of the resist material. When the amount is less than 0.01 wt. %, effects for improving coating characteristics and storage stability cannot be exhibited stably. Amounts exceeding 2 wt. %, on the other hand, may deteriorate the resolution of the resist material.

In addition, the resist material of the invention may contain, as an optional component, one or more surfactants ordinarily employed for improving the coating characteristics. The optional component may be added in a conventional amount within a range not disturbing the exhibition of the advantage of the invention, for example, 10 to 5000 ppm, preferably 50 to 1000 ppm based on the whole resist solution.

As the surfactant, nonionic ones are preferred. Examples include perfluoroalkylpolyoxyethylene ethanols, fluorinated alkyl esters, perfluoroalkylamine oxides, perfluoroalkyl EO adducts, and fluorinated organosiloxane compounds. Specific examples include Florade “FC-430” and “FC-431” (each, trade name; product of Sumitomo 3M, Ltd.), Surflon “S-141”, “S-145”, “KH-10”, “KH-20”, “KH-30” and “KH-40” (trade name; product of Asahi Glass Co., Ltd.), Unidyne “DS-401”, “DS-403” and “DS-451” (each, trade name; product of Daikin Industry Co., Ltd.), Megaface “F-8151” (trade name; product of Dai-Nippon Ink & Chemicals, Inc.), and “X-70-0921” and “X-70-093” (trade name; product of Shin-Etsu Chemical Co., Ltd.), with Florade “FC-430” (product of Sumitomo 3M, Ltd.) and “X-70-093” (product of Shin-Etsu Chemical Co., Ltd.) being preferred.

The resist material of the invention can be prepared by mixing the above-described components by a known technique and then filtering the mixture by a suitable method.

To pattern formation using the resist material of the invention, a known lithographic technique can be applied. For example, the resist material is applied onto a substrate such as a silicon wafer by spin coating to form thereon a resist film having a thickness of 0.2 to 2.0 μm, followed by pre-baking on a hot plate at 60 to 150° C. for 1 to 10 minutes, preferably at 80 to 130° C. for 1 to 5 minutes. A mask used for forming a desired pattern is then placed over the resist film. After the film is exposed to high-energy radiation such as far-UV rays, an excimer laser, or x-rays, or electron beams at a dose of about 1 to 200 mJ/cm², preferably about 5 to 100 mJ/cm², post exposure baking (PEB) is conducted on a hot plate at 60 to 150° C. for 1 to 5 minutes, at 80 to 130° C. for 1 to 3 minutes. Development is then conducted by using, as a developer, an aqueous alkali solution, such as a 0.1 to 5%, preferably 2 to 3%, of an aqueous solution of tetramethylammonium hydroxide (TMAH), in a conventional manner such as dipping, puddling, or spraying for 0.1 to 3 minutes, preferably 0.5 to 2 minutes, whereby the desired pattern is formed on the substrate. The material of the present invention is suited for micropattern formation by using high energy radiation, particularly, far ultraviolet rays having a wavelength of 248 to 193 nm, an excimer laser or x-rays, or electron beams. Outside the above-described range, however, the desired pattern is not always available.

The present invention will hereinafter be described in detail by Synthesis Examples, Examples and comparative Examples. It should however be borne in mind that the present invention is not limited to or by them.

### SYNTHESIS EXAMPLES

The epoxy compound of the present invention was synthesized in accordance with the following formulation.

### Synthesis Example 1-1

### Synthesis of 5-methoxymethyl-7-oxa-2-norbornene (Structural Formula 13)

To a mixture of 3.8 g of lithium aluminum hydride and 100 ml of dry tetrahydrofuran was added 15.4 g of methyl 7-oxa-5-norbornen-2-carboxylate over 1 hour at 30° C. under a nitrogen atmosphere. After stirring for 3 hours, 3.8 g of water was added to terminate the reaction. To the reaction mixture were added 3.8 g of a 15% aqueous sodium hydroxide solution and 11.4 g of water. The resulting mixture was filtered, followed by concentration. The residue was purified by distillation under reduced pressure, whereby 11.9 g of 5-hydroxymethyl-7-oxa-2-norbornene was obtained (boiling point: 86 to 88° C./80 Pa, yield: 95%). The product thus obtained was added to a mixture of 2.6 g of sodium hydride and 100 ml of dry tetrahydrofuran at 20° C. under a nitrogen atmosphere. After stirring for 1 hour, the mixture was heated to 40° C. and 19.9 g of methyl iodide was added. The resulting mixture was stirred for 2 hours at this temperature. Water was then added to terminate the reaction, followed by separation into phases. The organic phase was washed with brine, dried over anhydrous sodium sulfate and then concentrated under reduced pressure. The residue was purified by distillation under reduced pressure, whereby 11.1 g of 5-methoxymethyl-7-oxa-2-norbornene was obtained (boiling point: 67 to 70° C./1.06×10³ Pa, yield: 88%).

IR (thin film): ν=3075, 2998, 2975, 2933, 2871, 2827, 1479, 1450, 1386, 1338, 1315, 1201, 1151, 1112, 1035, 1002, 964, 944, 917, 854, 709, 686 cm⁻¹

¹H-NMR (300 MHz in CDCl₃) of the main isomer: δ=0.67(1H,dd), 1.94-2.02(1H,m), 2.43-2.54(1H,m), 2.93(1H,t), 3.23-3.34(4H,m), 4.91-4.98(2H,m), 6.23(1H,dd), 6.36(1H,dd).

### Synthesis Example 1-2

### Synthesis of 5-acetoxymethyl-7-oxa -2-norbornene (structural Formula (15))

To a mixture of 33.8 g of 5-hydroxymethyl-7-oxa-2-norbornene, 31.8 g of pyridine and 0.1 g of 4-dimethylaminopyridine, 35.6 g of acetic anhydride was added over 1 hour at 25° C. After stirring for 8 hours, 50 g of water was added to terminate the reaction. The reaction mixture was then extracted with ethyl acetate. The organic phase was washed with brine, dried over anhydrous sodium sulfate and concentrated under reduced pressure. The residue was then purified by distillation under reduced pressure, whereby 41.9 g of 5-acetoxymethyl-7-oxa-2-norbornene was obtained (boiling point: 73 to 74° C./35 Pa, yield: 93%).

IR (thin film): ν=3077, 3002, 2950, 2894, 2873, 1739, 1386, 1367, 1317, 1236, 1155, 1095, 1037, 1002, 975, 919, 852, 771, 711 cm⁻¹

¹H-NMR (300 MHz in CDCl₃) of the main isomer: δ=0.75(1H,dd), 1.99-2.07(4H,m), 2.45-2.56(1H,m), 3.58(1H,t), 3.99(1H,dd), 4.95(2H,m), 6.25(1H,dd), 6.41(1H,dd).

### Synthesis Example 1-3

### Synthesis of 5-pivaloyloxymethyl-7-oxa-2-norbornene (structural Formula (17))

In a similar manner to Synthesis Example 2 except for the use of pivalic acid chloride instead of acetic anhydride, 5-pivaloyloxymethyl-7-oxa-2-norbornene was obtained (boiling point: 97 to 98° C./133 Pa, yield: 91%).

IR (thin film): ν=3077, 2973, 2908, 2873, 1727, 1481, 1461, 1398, 1365, 1315, 1284, 1155, 1095, 1035, 998, 973, 919, 854, 798, 769, 709, 682 cm⁻¹

¹H-NMR (300 MHz in CDCl₃) of the main isomer: δ=0.76(1H,dd), 1.19 (9H,s), 1.32-1.44(1H,m), 2.46-2.58(1H,m), 3.57(1H,t), 4.00(1H,dd), 4.94(2H,m), 6.24(1H,dd), 6.40(1H,dd).

### Synthesis Example 1-4

### Synthesis of 5-α-acetoxyisopropyl-7-oxa-2-norbornene (Structural Formula (25))

To 200 ml of 2.0 M tetrahydrofuran solution of methyl magnesium chloride was added 23.8 g of 7-oxa-5-norbornene-2-carbonyl chloride over 1 hour at 20° C. under a nitrogen atmosphere. After stirring for 2 hours, a saturated aqueous solution of ammonium chloride was added to terminate the reaction and the resulting mixture was separated into phases. The organic phase was washed with brine, dried over anhydrous sodium sulfate and concentrated under reduced pressure, whereby crude 5-α-hydroxyisopropyl-7-oxa-2-norbornene was obtained. To the crude product were added 1.0 of 4-dimethylaminopyridine, 19.0 g of pyridine and 50 ml of toluene, followed by heating to 70° C. Acetic anhydride (21.4 g) was added over 1 hour and stirring of the mixture was continued for 8 hours. The reaction mixture was cooled to 20° C. Water was then added to terminate the reaction. The reaction mixture was extracted with ethyl acetate. The organic phase was washed with brine, dried over anhydrous sodium sulfate and concentrated under reduced pressure. The residue was purified by distillation under reduced pressure, whereby 25.3 g of 5-α-acetoxyisopropyl-7-oxa-2-norbornene was obtained (boiling point: 65 to 67° C./24 Pa, yield: 86%).

IR (thin film): v=3077, 2998, 2948, 1731, 1456, 1369, 1315, 1253, 1195, 1149, 1124, 1020, 929, 900, 813, 717, 696 cm⁻¹

¹H-NMR (300 MHz in CDCl₃) of the main isomer: δ=1.30-1.37(1H,m), 1.40(3H,s), 1.45-1.52(4H,m), 1.97(3H,s), 2.19-2.23(1H,m), 4.77(1H,m), 4.92-4.94(1H,m), 6.28(1H,dd), 6.36(1H,dd).

### Synthesis Example 2

The polymer compound of the invention was synthesized in the below-described formulation.

### Synthesis Example 2-1

### Synthesis of Polymer 1

The epoxy compound (14.0 g) of the structural formula 13, 104.0 g of 2-ethyl-2-norbornyl 5-norbornene-2-carboxylate, 49.0 g of maleic anhydride and 18.5 g of 1,4-dioxane were mixed. The resulting mixture was heated to 60° C., followed by the addition of 7.4 g of 2,2′-azobis(2,4-dimethylvaleronitrile). The mixture was stirred for 15 hours at a temperature maintained at 60° C. After cooling to room temperature, the reaction mixture was dissolved in 500 ml of acetone. The resulting solution was added dropwise to 10 L of isopropyl alcohol while vigorous stirring. The solid thus precipitated was filtered off and the residue was vacuum dried at 40° C. for 15 hours, whereby a polymer compound as shown by the below-described formula of Polymer 1 was obtained in the form of a white powdery solid. The amount obtained was 71.8 g and the yield was 43%. In the formula, Mw means a weight average molecular weight as measured by GPC in terms of polystyrene.

### Synthesis Examples 2-2 to 2-8

### Synthesis of Polymers 2 to 8

In a similar manner or in a known manner, Polymers 2 to 8 were synthesized.

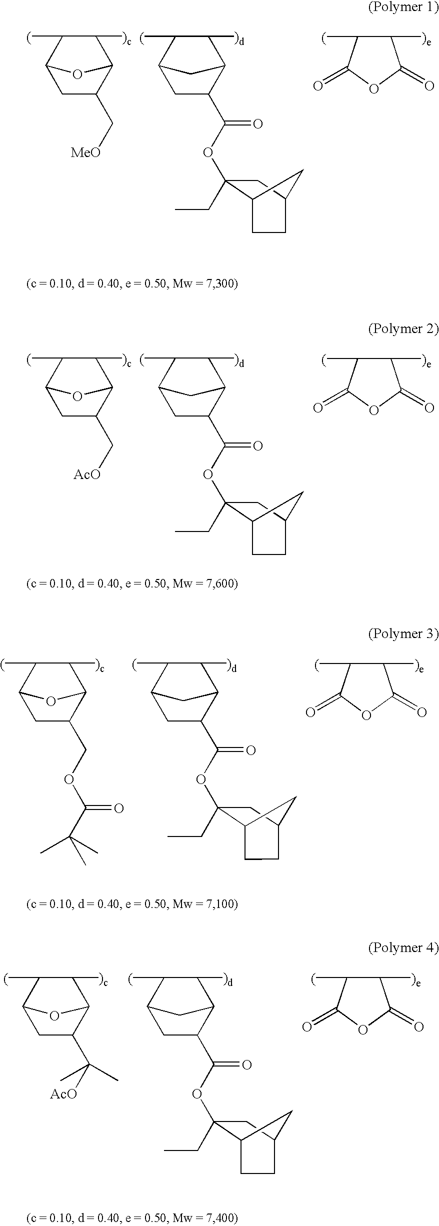

### EXAMPLE 1

Adhesion, to a substrate, of the polymer compounds of the invention incorporated in a resist material as a base resin was evaluated.

### EXAMPLES 1-1 TO 1-8 AND COMPARATIVE EXAMPLES 1-1 and 1-2

Using the above-described polymers (Polymers 1 to 8) containing the epoxy compound of the invention as recurring units or the below-described polymers (Polymers 9, 10) for comparison free of the epoxy compound of the present invention as a base resin, an acid generator, a basic compound and a solvent were mixed in accordance with the composition as shown in Table 1. Each of the resulting mixtures was filtered through a Teflon (trade mark) filter (pore size: 0.2 μm), whereby a resist material was prepared. In Table 1, the acid generator, basic compound and solvent employed are indicated as the corresponding abbreviation below. In any of these materials, a solvent containing 0.01 wt. % of “FC-430” (product of Sumitomo 3M Co., Ltd.) was employed.

TPSNf: triphenylsulfonium nonafluorobutanesulfonate

TMMEA: trismethoxymethoxyethylamine

PGMEA: propylene glycol methyl ether acetate

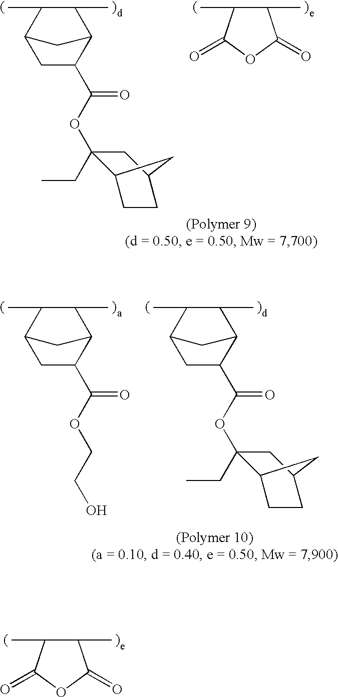

Each of the resist solutions was spin coated onto a silicon wafer sprayed with hexamethyldisilazane at 90° C. for 40 seconds, followed by heat treatment at 110C for 90 seconds, whereby a resist film having a thickness of 0.5 μm was formed. After exposure of the resulting resist film by using a KrF excimer laser stepper (product of Nikon Corporation; NA: 0.5) and heat treatment at 110° C. for 90 seconds, puddle development was conducted using a 2.38% aqueous tetramethylammonium hydroxide solution for 60 seconds to form 1:1 line-and-space patterns. The wafer after development was observed under overhead SEM (scanning electron microscope). The minimum width (μm) of lines left unstripped is designated as the limit of adhesion of the resist.

The composition and test results of each of the resists are shown in Table 1.

TABLE 1

| | | Resin | Acid generator | | Solvent | Limit of |
|---|---|---|---|---|---|---|
| | | (parts by | (parts by | Basic compound | (parts by | adhesion |
| | | weight) | weight) | (parts by weight) | weight) | (μm) |
| Ex. | 1-1 | Polymer 1 | TPSNf | TMMEA | PGMEA | 0.28 |
| | | (80) | (1,090) | (0.236) | (480) | |
| | 1-2 | Polymer 2 | TPSNf | TMMEA | PGMEA | 0.26 |
| | | (80) | (1,090) | (0.236) | (480) | |
| | 1-3 | Polymer 3 | TPSNf | TMMEA | PGMEA | 0.29 |
| | | (80) | (1,090) | (0.236) | (480) | |
| | 1-4 | Polymer 4 | TPSNf | TMMEA | PGMEA | 0.26 |
| | | (80) | 1,090 | (0.236) | (480) | |
| | 1-5 | Polymer 5 | TPSNf | TMMEA | PGMEA | 0.20 |
| | | (80) | (1,090) | (0.236) | (480) | |
| | 1-6 | Polymer 6 | TPSNf | TMMEA | PGMEA | 0.19 |
| | | (80) | (1,090) | (0.236) | (480) | |
| | 1-7 | Polymer 7 | TPSNf | TMMEA | PGMEA | 0.23 |
| | | (80) | (1,090) | (0.236) | (480) | |
| | 1-8 | Polymer 8 | TPSNf | TMMEA | PGMEA | 0.20 |
| | | (80) | (1,090) | (0.236) | (480) | |
| Comp. | 1-1 | Polymer 9 | TPSNf | TMMEA | PGMEA | >0.50 |
| Ex. | | (80) | (1,090) | 0.236) | (480) | |
| | 1-2 | Polymer 10 | TPSNf | TMMEA | PGMEA | >0.50 |
| | | (80) | (1,090) | (0.236) | (480) | |

It has been confirmed from the results of Table 1 that the polymer compounds containing the epoxy compound of the present invention as recurring units have high adhesion to substrate.

### EXAMPLE 2

Resolution property of the resist material of the present invention when exposed to an ArF excimer laser light was evaluated.

### EXAMPLES 2-1 TO 2-8

### Evaluation of the Resolution Property of Resist

With the above-described polymers (Polymers 1 to 8) as a base resin, an acid generator, a basic compound and a solvent were mixed in accordance with the composition as shown in Table 2. Each of the resulting mixtures was filtered through a Teflon (trade mark) filter (pore size: 0.2 μm), whereby a resist material was prepared. In Table 2, the acid generator, basic compound and solvent employed are indicated as the corresponding abbreviations. In any of these materials, a solvent added with 0.01 wt. % of “FC-430” (product of Sumitomo 3M Co., Ltd.) was employed.

TPSNf: triphenylsulfonium nonafluorobutanesulfonate

TMMEA: trismethoxymethoxyethylamine

PGMEA: propylene glycol methyl ether acetate

Each of the resist solutions was spin coated onto a silicon wafer coated with antireflective film (“ARC 25”, trade name; product of Nissan Chemical Co., Ltd., 77 nm) had been applied, followed by heat treatment at 110° C. for 60 seconds, whereby a resist film having a thickness of 375 nm was formed. After exposure of the resulting resist film to a light of a KrF excimer laser stepper (product of Nikon Corporation; NA: 0.55) and heat treatment at 110° C. for 60 seconds, puddle development was conducted using a 2.38% aqueous tetramethylammonium hydroxide solution for 60 seconds to form 1:1 line-and-space patterns. The wafer after development was cut in cross-section and observed under cross-section SEM (scanning electron microscope). The minimum line width (μm) of the line-and space separated at an exposure amount (the optimum exposure amount=Eop, mJ/cm²) for resolving the line-and-space of 0.20 μm at 1:1 is designated as the resolution degree of the resist. The pattern shape observed was classified into any one of rectangular, top round, T-top, forward tapered and inverse tapered. The composition and evaluation results of each resist are shown in Table 2.

TABLE 2

| | | | Acid | Basic | | Optimum | | |
|---|---|---|---|---|---|---|---|---|
| | | Resin | generator | compound | Solvent | exposure | Resolution | |
| | | (parts by | (parts by | (parts by | (parts by | amount | degree | |
| | | weight) | weight) | weight) | weight) | (mJ/cm²) | (μM) | Shape |
| Ex. | 2-1 | Polymer 1 | TPSNf | TMMEA | PGMEA | 28.0 | 0.17 | Rectangular |
| | | (80) | (1,090) | (0.236) | (480) | | | |
| | 2-2 | Polymer 2 | TPSNf | TMMEA | PGMEA | 30.0 | 0.17 | Rectangular |
| | | (80) | (1,090) | (0.236) | (480) | | | |
| | 2-3 | Polymer 3 | TPSNf | TMMEA | PGMEA | 29.0 | 0.16 | Rectangular |
| | | (80) | (1,090) | (0.236) | (480) | | | |
| | 2-4 | Polymer 4 | TPSNf | TMMEA | PGMEA | 28.0 | 0.16 | Rectangular |
| | | (80) | (1,090) | (0.236) | (480) | | | |
| | 2-5 | Polymer 5 | TPSNf | TMMEA | PGMEA | 29.0 | 0.15 | Rectangular |
| | | (80) | (1,090) | (0.236) | (480) | | | |
| | 2-6 | Polymer 6 | TPSNf | TMMEA | PGMEA | 32.0 | 0.15 | Rectangular |
| | | (80) | (1,090) | (0.236) | (480) | | | |
| | 2-7 | Polymer 7 | TPSNf | TMMEA | PGMEA | 24.0 | 0.16 | Rectangular |
| | | (80) | (1,090) | (0.236) | (480) | | | |
| | 2-8 | Polymer 8 | TPSNf | TMMEA | PGMEA | 27.0 | 0.17 | Rectangular |
| | | (80) | (1,090) | (0.236) | (480) | | | |

It has been confirmed from the results of Table 2 that the resist material of the present invention exhibits high sensitivity and high resolution upon exposure to an ArF excimer laser light.

What is claimed is:

1. An epoxy compound represented by the following formula (1): 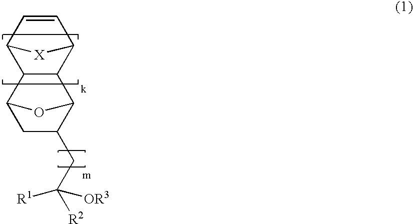
wherein, R¹ and R² each independently represents a hydrogen atom or a linear, branched or cyclic C₁₋₁₀ alkyl group in which hydrogen atoms on one or more constituent carbon atoms thereof may be partially or entirely substituted by one or more halogen atoms, or constituent —CH₂— thereof may be substituted by an oxygen atom, or R¹ and R² may be coupled together to form an aliphatic hydrocarbon ring; R³ represents a linear, branched or cyclic C₁₋₁₀ alkyl group or a C₁₋₁₅ acyl or alkoxycarbonyl group in which hydrogen atoms on one or more constituent carbon atoms thereof may be partially or entirely substituted by one or more halogen atoms; X represents CH₂, oxygen or sulfur; k stands for 0 or 1; and m stands for an integer of 0 to 5.

2. An epoxy compound of claim 1 which is represented by the following formula (2): 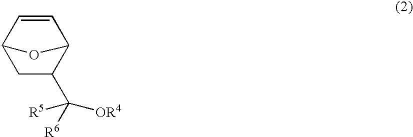
wherein, R⁴ represents a linear, branched or cyclic C₁₋₁₀ alkyl group, a C₁₋₁₅ acyl or alkoxycarbonyl group, wherein hydrogen atoms on one or more constituent carbon atoms thereof may be partially or entirely substituted with one or more halogen atoms, and R⁵ and R⁶ each independently represents a hydrogen atom or a linear, branched or cyclic C₁₋₆ alkyl group.

3. A polymer compound comprising one or more recurring units derived from an epoxy compound of claim 1.

4. A polymer compound comprising one or more recurring units derived from an epoxy compound of claim 2.

5. A resist material comprising a polymer compound of claim 3 as a base resin.

6. A resist material comprising a polymer compound of claim 4 as a base resin.

7. A patterning method comprising the steps of: applying a resist material of claim 5 onto a substrate; exposing the substrate to high energy radiation or electron beams through a photomask after heat treatment; and developing with a developer after heat treatment.

8. A patterning method comprising the steps of: applying a resist material of claim 6 onto a substrate; exposing the substrate to high energy radiation or electron beams through a photomask after heat treatment; and developing with a developer after heat treatment.
